(19) United States
(12) Patent Application Publication
(10) Pub. No.: US 2018/0073726 A1
(43) Pub. Date: Mar. 15, 2018

(54) HEAT AND HYDROGEN GENERATION DEVICE

(71) Applicant: TOYOTA JIDOSHA KABUSHIKI KAISHA, Toyota-shi (JP)

(72) Inventors: Shinichi TAKESHIMA, Numazu-shi (JP); Hiromasa NISHIOKA, Susono-shi (JP); Kiyoshi FUJIWARA, Susono-shi (JP)

(73) Assignee: TOYOTA JIDOSHA KABUSHIKI KAISHA, Toyota-shi (JP)

(21) Appl. No.: 15/651,252

(22) Filed: Jul. 17, 2017

(30) Foreign Application Priority Data
Sep. 14, 2016 (JP) 2016-179580

(51) Int. Cl. F23C 5/08; F23C 7/00; F23C 7/06; F23C 9/00; C01B 3/32

(52) U.S. Cl. CPC F23C 5/08; F23C 7/008; F23C 7/06; F23C 9/006; C01B 2203/10; F23C 2900/03005; C01B 2203/0811; C01B 2203/0827; C01B 3/323

(57) ABSTRACT

A heat and hydrogen generation device comprising a burner combustion chamber (3), a burner (7) for feeding fuel and air into the burner combustion chamber (3), and a reformer catalyst (4). The target value of the O₂/C molar ratio of air and fuel which are made to react in the burner combustion chamber (3) is preset as the target O₂/C molar ratio. The actual O₂/C molar ratio at the time of warm-up operation is estimated from the rate of temperature rise of the reformer catalyst (4) etc., when performing warm-up operation. When the estimated actual O₂/C molar ratio deviates from the target O₂/C molar ratio at the time of warm-up operation, the ratio of feed between the amount of feed of air for burner combustion and the amount of feed of fuel for burner combustion is corrected, in a direction making the estimated actual O₂/C molar ratio approach the target O₂/C molar ratio at the time of warm-up operation.

### TECHNICAL FIELD

The present invention relates to a heat and hydrogen generation device.

### BACKGROUND ART

Known in the art is a fuel reformer provided with a reformer catalyst and a fuel gas feed device for feeding the reformer catalyst with fuel gas comprised of fuel and air and designed to cause the fuel and air contained in the fuel gas fed from the fuel gas feed device to react by a partial oxidation reaction in a reformer catalyst so as to generate reformed gas containing hydrogen and carbon monoxide (for example, see Japanese Patent Publication No. 2010-270664A). In such a fuel reformer, at the time of generation of the reformed gas, usually the O₂/C molar ratio of air and fuel which are made to react is maintained at a target O₂/C molar ratio suitable for a partial oxidation reaction, the temperature of the reformer catalyst is maintained at a reaction equilibrium temperature, and a warm-up operation of the fuel reformer is performed to make the temperature of the reformer catalyst rise to the reaction equilibrium temperature. In this case, in the above-mentioned known fuel reformer, the reformer catalyst is heated by an electric heater for the warm-up action of the reformer catalyst.

### SUMMARY OF INVENTION

### Technical Problem

In this regard, when warming up the reformer catalyst by using the heat of reaction generated when fuel is burned, at the time of the warm-up operation, the O₂/C molar ratio of the air and fuel which are made to react is made a target O₂/C molar ratio suitable for a warm-up operation, and if the temperature of the reformer catalyst reaches the reaction equilibrium temperature, the O₂/C molar ratio of the air and fuel which are made to react is maintained continuously at a target O₂/C molar ratio suitable for a partial oxidation reaction. However, in this case, if clogging of the air feed port or fuel feed port etc., causes the amount of feed, of air and the amount of feed of fuel to change, the amount of feed of air or amount of feed of fuel deviates from the target amount of feed of air or target amount of feed of fuel corresponding to the target O₂/C molar ratio. As a result, the actual O₂/C molar ratio deviates from the target O₂/C molar ratio. If the actual O₂/C molar ratio deviates from the target O₂/C molar ratio in this way, for example, when the actual O₂/C molar ratio becomes smaller than the target O₂/C molar ratio, the fuel becomes in excess, so the surplus carbon in the fuel deposits in the pores of the substrate of the reformer catalyst resulting in so-called “coking”. As opposed to this, when the actual O₂/C molar ratio becomes excessively larger than the target O₂/C molar ratio, the reaction equilibrium temperature rises, so the problem is caused of the reformer catalyst overheating. In this way, when warming up the reformer catalyst by using the heat of reaction generated when fuel is burned, if the actual O₂/C molar ratio deviates from the target O₂/C molar ratio, various problems are caused.

An object of the present invention is to provide a heat and hydrogen generation device designed to prevent as much as possible coking of the reformer catalyst or overheating of the reformer catalyst when warming up the reformer catalyst by using the heat of reaction generated when fuel is burned.

### Solution to Problem

According to the present invention, to solve this problem, there is provided a heat and hydrogen generation device comprising:

a burner arranged in a burner combustion chamber for burner combustion,

a fuel feed device able to control an amount of feed of fuel for burner combustion fed into the burner combustion chamber,

an air feed device able to control an amount of feed of air for burner combustion fed into the burner combustion chamber,

an ignition device for making the fuel for burner combustion ignite,

a reformer catalyst to which burner combustion gas is sent; and

an electronic control unit,

wherein an operation of the heat and hydrogen generation device is switched from a warm-up operation to a normal operation when a temperature of the reformer catalyst reaches a reaction equilibrium temperature, and target values of O₂/C molar ratio of air and fuel which are made to react in the burner combustion chamber are preset as target O₂/C molar ratios for a time of the warm-up operation and for a time of the normal operation, respectively,

the electronic control unit being configured to estimate an actual O₂/C molar ratio at the time of the warm-up operation from a rate of temperature rise of the reformer catalyst, an amount of temperature rise of the reformer catalyst, or time required for temperature rise of the reformer catalyst when performing the warm-up operation and correct a ratio of feed between the amount of feed of air for burner combustion and the amount of feed of fuel for burner combustion in a direction making the estimated actual O₂/C molar ratio approach the target O₂/C molar ratio when the estimated actual O₂/C molar ratio deviates from the target O₂/C molar ratio,

### Advantageous Effects of Invention

According to the present invention, at the time of warm-up operation, when the estimated actual O₂/C molar ratio deviates from the target O₂/C molar ratio, the ratio of feed between the amount of feed of air for burner combustion and the amount of feed of fuel for burner combustion is corrected in a direction where the deviation is eliminated, so coking of the reformer catalyst or overheating of the reformer catalyst is suppressed. Further, the actual O₂/C molar ratio is estimated from the rate of temperature rise of the reformer catalyst, amount of temperature rise of the reformer catalyst, or time required for temperature rise of the reformer catalyst, so there is the advantage that an inexpensive temperature sensor can be used to correct the ratio of feed between the amount of feed of air for burner combustion and the amount of feed of fuel for burner combustion.

### BRIEF DESCRIPTION OF DRAWINGS

FIG. 1 is an overview of a heat and hydrogen generation device.

FIG. 2 is a view for explaining a reforming reaction of diesel oil.

FIG. 3 is a view showing a relationship between a reaction equilibrium temperature TB and an O₂/C molar ratio.

FIG. 4 is a view showing a relationship between a number of molecules formed per carbon atom and an O₂/C molar ratio.

FIG. 5 is a view showing a temperature distribution in a reformer catalyst.

FIG. 6 is a view showing a relationship between a reaction equilibrium temperature and an O₂/C molar ratio TB when a temperature TA of air fed changes.

FIG. 7 is a time chart showing heat and hydrogen generation control.

FIGS. 8A and 8B are views showing an operating region where secondary warm-up is performed.

FIG. 9 is a time chart showing a first embodiment of heat and hydrogen generation control according to the present invention.

FIG. 10 is a time chart showing a first embodiment of heat and hydrogen generation control according to the present invention.

FIG. 11 is a flow chart of a first embodiment for heat and hydrogen generation control.

FIG. 12 is a flow chart of a first embodiment for heat and hydrogen generation control.

FIG. 13 is a flow chart of a first embodiment for heat and hydrogen generation control.

FIG. 14 is a flow chart of a first embodiment for heat and hydrogen generation control.

FIG. 15 is a flow chart of a first embodiment for heat and hydrogen generation control.

FIG. 16 is a flow chart of a first embodiment for heat and hydrogen generation control.

FIG. 17 is a flow chart of a first embodiment for heat and hydrogen, generation control.

FIG. 18 is a flow chart of a first embodiment for heat and hydrogen generation control.

FIG. 19 is a flow chart of a first embodiment for heat and hydrogen generation control.

FIG. 20 is a flow chart for control for restricting the rise of the catalyst temperature.

FIGS. 21A and 21B are views showing an operating region where secondary warm-up is performed.

FIG. 22 is a time chart of a second embodiment for heat and hydrogen generation control.

FIG. 23 is a time chart of a second embodiment for heat and hydrogen generation control.

FIG. 24 is a flow chart of a second embodiment for heat and hydrogen generation control.

FIG. 25 is a flow chart of a second embodiment for heat and hydrogen generation control.

FIG. 26 is a flow chart of a second embodiment for heat and hydrogen generation control.

FIG. 27 is a flow chart of a second embodiment, for heat and hydrogen generation control.

FIG. 28 is a flow chart of a second embodiment for heat and hydrogen generation control.

FIG. 29 is at flow chart of a second embodiment for heat and hydrogen generation control.

FIG. 30 is a flow chart of a second embodiment for heat and hydrogen generation control.

### DESCRIPTION OF EMBODIMENTS

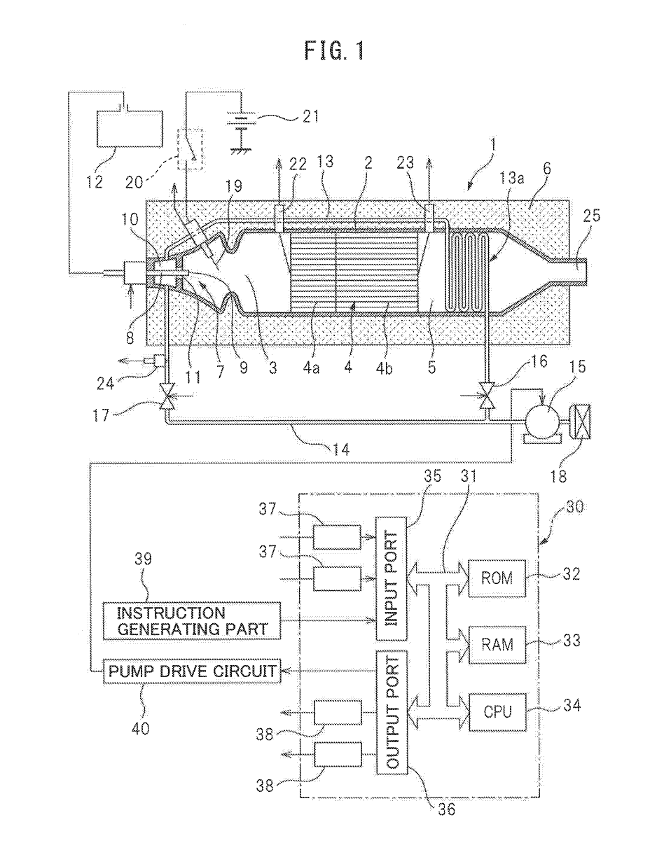

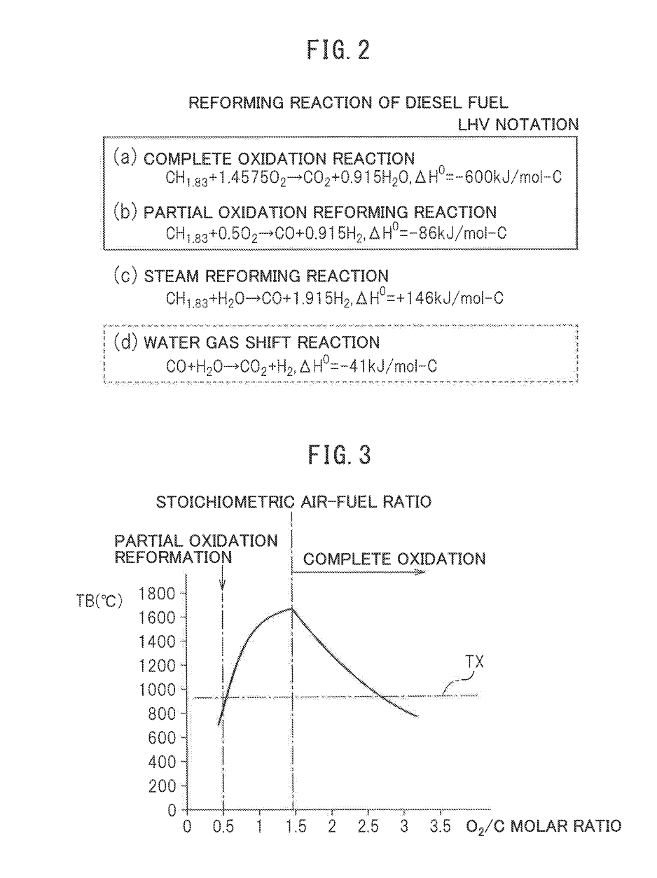

FIG. 1 is an overall view of a heat and hydrogen generation device 1. This heat and hydrogen generation device 1 is cylindrically shaped as a whole. Referring to FIGS. 1, 2 indicates a cylindrical housing of the heat and hydrogen generation device 1, 3 a burner combustion chamber formed in the housing 2, 4 a reformer catalyst arranged in the housing 2, and 5 a gas outflow chamber formed in the housing. In the embodiment shown in FIG. 1, the reformer catalyst 4 is arranged at the center of the housing 2 in the longitudinal direction, the burner combustion chamber 3 is arranged at one end part of the housing 2 in the longitudinal direction, and the gas outflow chamber 5 is arranged at the other end part of the housing 2 in the longitudinal direction. As shown in FIG. 1, in this embodiment, the entire outer circumference of the housing 2 is covered by a heat insulating material 6.

As shown in FIG. 1, a burner 7 provided with a fuel injector 8 is arranged at one end part of the burner combustion chamber 3. The tip of the fuel injector 8 is arranged in the burner combustion chamber 3, and a fuel injection port 9 is formed at the tip of the fuel injector 8. Further, an air chamber 10 is formed, around the fuel injector 8, and an air feed port 11 for ejecting air in the air chamber 10 toward the inside of the burner combustion chamber 3 is formed around the tip of the fuel injector 8. In the embodiment shown in FIG. 1, the fuel injector 8 is connected to a fuel tank 12, and fuel inside the fuel tank 12 is injected from the fuel injection port 9 of the fuel injector 8. In the embodiment shown in FIG. 1, this fuel is comprised of diesel fuel.

The air chamber 10 is connected on one hand through a high temperature air flow passage 13 to an air pump 15 able to control the discharge rate and is connected on the other hand through a low temperature air flow passage 14 to the air pump 15 able to control the discharge rate. As shown in FIG. 1, a high temperature air valve 16 and low temperature air valve 17 are arranged in the high temperature air flow passage 13 and the low temperature air flow passage 14, respectively. Further, as shown in FIG. 1, the high temperature air flow passage 13 is provided with a heat exchange part arranged in the gas outflow chamber 5. This heat exchange part is shown diagrammatically in FIG. 1 by reference notation 13a. Note that, this heat exchange part may also be formed downstream of the reformer catalyst 4 around, the housing 2 defining the gas outflow chamber 5. That is, it is preferable that this heat, exchange part 13a is arranged or formed at a location where a heat exchange action is performed using the heat of the high temperature gas flowing out from the gas outflow chamber 5. On the other hand, the low temperature air flow passage 14 does not have the heat exchange part 13a performing the heat exchange action using the heat of the high temperature gas flowing out from the gas outflow chamber 5 in this way.

If the high temperature air valve 16 opens and the low temperature air valve 17 is made to close, the outside air is fed through the air cleaner 18, air pump 15, high temperature air flow passage 13, and air chamber 10 into the burner combustion chamber 3 from the air feed, port 11. At this time, the outside air, that is, air, is made to flow within the heat exchange part 13a. As opposed to this, if the low temperature air valve 17 opens and the high temperature air valve 16 is made to close, the outside air, that is, the air, is fed through the air cleaner 18, air pump 15, low temperature air flow passage 14, and air chamber 10 from the air feed port 11. Therefore; the high temperature air valve 16 and low temperature air valve 17 form a switching device able to switch the air flow passage for feeding air through the air chamber 10 to the air feed port 11 between the high temperature air flow passage 13 and the low temperature air flow passage 14.

On the other hand, an ignition device 19 is arranged in the burner combustion chamber 3. In the embodiment shown in FIG. 1, this ignition device 19 is comprised of a glow plug. This glow plug 19 is connected through a switch 20 to a power supply 21. On the other hand, in the embodiment shown in FIG. 1, the reformer catalyst 4 is comprised of an oxidizing part 4a and a reforming part 4b. In the example shown in FIG. 1, the substrate of the reformer catalyst 4 is comprised of zeolite. On this substrate, at the oxidizing part 4a, mainly palladium Pd is carried, while at the reforming part 4b, mainly rhodium Rh is carried. Further, a temperature sensor 22 for detecting the temperature of the upstream side end face of the oxidizing part 4a of the reformer catalyst 4 is arranged, in the burner combustion chamber 3, and a temperature sensor 2 3 for detecting the temperature of the downstream side end face of the reforming part 4b of the reformer catalyst 4 is arranged in the gas outflow chamber 5. Furthermore, a temperature sensor 24 for detecting the temperature of the air flowing within the low temperature air flow passage 14 is arranged in the low temperature air flow passage 14 positioned at the outside of the heat insulating material 6.

As shown in FIG. 1, the heat and hydrogen generation device 1 is provided with an electronic control unit 30. This electronic control unit 30 is comprised of a digital computer provided with, as shown in FIG. 1, a ROM (read only memory) 32, RAM (random access memory) 33, CPU (microprocessor) 34, input port 35, and output port 36, which are interconnected with each other by a bidirectional bus 31. The output signals of the temperature sensors 22, 23, and 2 4 are input through corresponding AD converters 37 to the input port 35 respectively. Further, an output signal showing the resistance value of the glow plug 19 is input through a corresponding AD converter 37 to the input port 35. Furthermore, various instructions from the instruction generating part 39 generating various types of instructions are input to the input port 35.

On the other hand, the output port 36 is connected through corresponding drive circuits 38 to the fuel injectors 8, high temperature air valve 16, low temperature air valve 17, and switch 20. Furthermore, the output port 36 is connected to a pump drive circuit 40 controlling the discharge rate of the air pump 15. The pump driving power necessary to discharge the target feed air amount from the air pump 15 is fed to the air pump 15 from the pump drive circuit 40.

At the time of start of operation of the heat and hydrogen generation device 1, fuel injected from the burner 7 is ignited by the glow plug 19. Due to this, the fuel and air which are fed from the burner 7 react in the burner combustion chamber 3, and whereby burner combustion is started. If burner combustion is started, the temperature of the reformer catalyst 4 gradually rises. At this time, the burner combustion is performed under a lean air-fuel ratio. Next, if the temperature of the reformer catalyst 4 reaches a temperature able to reform the fuel, the air-fuel ratio is switched from the lean air-fuel ratio to the rich air-fuel ratio and the reforming action of the fuel at the reformer catalyst 4 is started. If the reforming action of the fuel is started, hydrogen is generated and high temperature gas containing the generated hydrogen is made to flow out from a gas outflow port 25 of the gas outflow chamber 5.

That is, in an embodiment of the present invention, the heat and hydrogen generation device 1 is provided with the burner combustion chamber 3, the burner 7 arranged in the burner combustion chamber 3 for performing burner combustion, a fuel feed device able to control the amount of feed of the fuel fed from the burner 7 into the burner combustion chamber 3, an air feed device able to control the temperature and amount of feed of air fed from the burner 7 into the burner combustion chamber 3, the ignition device 19 for making the fuel ignite, the reformer catalyst 4 to which the burner combustion gas is fed, and the electronic control unit 30, and the air feed device is provided with the heat exchange part 13a for heating the air fed from the burner 7 into the burner combustion chamber 3 by the burner combustion gas.

In this case, in the embodiment of the present invention, the fuel injector 8 forms the above-mentioned fuel feed device. The air chamber 10, air feed port 11, high temperature air flow passage 13, heat exchange part 13a, low temperature air flow passage 14, air pump 15, high temperature air valve 16, and low temperature air valve 17 form the above-mentioned air feed device. Further, in the embodiment of the present invention, heat and hydrogen are generated by performing the burner combustion in the heat and hydrogen generation device 1.

The heat and hydrogen generated by the heat and hydrogen generation device 1 is used for example for warming up the exhaust purification catalyst of a vehicle. In this case, the heat and hydrogen generation device 1 is for example arranged inside the engine compartment of the vehicle. Of course, the heat and hydrogen generated by the heat and hydrogen generation device 1 is used for various other applications as well. Whatever the case, in the heat and hydrogen generation device 1, hydrogen is generated by reforming fuel. Therefore, first, referring to FIG. 2, reforming reactions In the case of using diesel fuel as fuel will be explained.

(a) to (c) in FIG. 2 show a reaction formula when a complete oxidation reaction is performed, a reaction formula when a partial oxidation reforming reaction is performed, and a reaction formula when a steam, reforming reaction is performed, respectively, with reference to the case of using the generally used diesel fuel as fuel. Note that, the heating value ΔH⁰ in the reaction formulas are shown by the lower heating value (LHV). Now, as will be understood from (b) and (c) in FIG. 2, to generate hydrogen from diesel fuel, there are two methods; the method of performing the partial oxidation reforming reaction and the method of performing the steam reforming reaction. The steam reforming reaction is the method of adding steam to diesel fuel, and as will be understood from (C) in FIG. 2, this steam reforming reaction is an endothermic reaction. Therefore, to cause the steam reforming reaction, it is necessary to add heat from the outside. In large scale hydrogen generating plants, usually, to raise the efficiency of generation of hydrogen, in addition to the partial oxidation reforming reaction, the steam reforming reaction in which the generated heat is not discarded, but using the generated heat for generating hydrogen is used.

As opposed to this, in the present invention, to generate both hydrogen and heat, the steam reforming reaction using the generated heat for generating hydrogen is not used. In the present invention, only the partial oxidation reforming reaction is used to generate hydrogen. This partial oxidation reforming reaction, as will be understood from, (b) in FIG. 2, is an exothermic reaction. Therefore, the reforming reaction proceeds by the heat generated on its own even without adding heat from the outside, and hydrogen is generated. Now, as shown by the reaction formula of the partial oxidation reforming reaction of (b) in FIG. 2, the partial oxidation reforming reaction is performed by a rich air-fuel ratio in which an O₂/C molar ratio, showing the ratio of the air and fuel which are made to react, is 0.5. At this time, CO and H₂ are generated,

FIG. 3 shows the relationship between a reaction equilibrium temperature TB when the air and fuel are reacted at the reformer catalyst and reach equilibrium and the O₂/C molar ratio of the air and fuel. Note that, the solid line in FIG. 3 shows the theoretical value when the air temperature is 25° C. As shown by the solid line in FIG. 3, when the partial oxidation reforming reaction is performed by a rich air-fuel ratio of an O₂/C molar ratio=0.5, the equilibrium reaction temperature TB becomes substantially 830° C. Note that, the actual equilibrium reaction temperature TB at this time becomes somewhat lower than 830° C., but below, the equilibrium, reaction temperature TB will be explained for an embodiment according to the present invention as the value shown by the solid, line in FIG. 3.

On the other hand, as will be understood from the reaction formula of the complete oxidation reaction, of (a) in FIG. 2, when the O₂/C molar ratio=1.4575, the ratio of the air and fuel becomes the stoichiometric air-fuel ratio. As shown in FIG. 3, the reaction equilibrium temperature TB becomes the highest when the ratio of the air and fuel becomes the stoichiometric air-fuel ratio. When an O₂/C molar ratio is between 0.5 and 1.4575, partially the partial oxidation reforming reaction is performed, while partially the complete oxidation reaction is performed. In this case, the larger the O₂/C molar ratio, the greater the ratio by which the complete oxidation reaction is performed compared with the ratio by which the partial oxidation reforming reaction is performed, so the larger the O₂/C molar ratio, the higher the reaction equilibrium temperature TB.

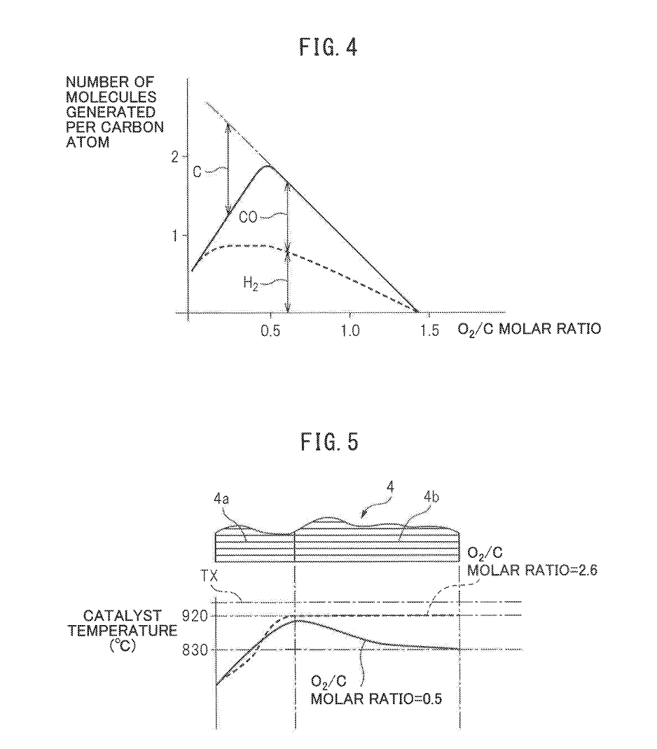

On the other hand, FIG. 4 shows the relationship between the number of molecules (H₂ and CO) produced per atom of carbon and the O₂/C molar ratio. As explained above, the more the O₂/C molar ratio exceeds 0.5, the less the ratio by which the partial oxidation reforming reaction is performed. Therefore, as shown in FIG. 4, the more the O₂/C molar ratio exceeds 0.5, the smaller the amounts of generation of H₂ and CO. Note that, while not described in FIG. 4, if the O₂/C molar ratio becomes larger than 0.5, due to the complete oxidation reaction shown in (a) of FIG. 2, the amounts of generation of CO₂ and H₂O increase. In this regard, FIG. 4 shows the amounts of generation of H₂ and CO when assuming no water gas shift reaction shown in FIG. 2(d) occurs. However, in actuality, the water gas shift reaction shown in (d) of FIG. 2 occurs due to the CO generated by the partial oxidation reforming reaction and the H₂O generated by the complete oxidation reaction, and hydrogen is generated by this water gas shift reaction as well.

Now then, as explained above, the more the O₂/C molar ratio exceeds 0.5, the less the amounts of generation of H₂ and CO. On the other hand, as shown in FIG. 4, if the O₂/C molar ratio becomes smaller than 0.5, excess carbon C unable to be reacted with, increases. This excess carbon C deposits inside the pores of the substrate of the reformer catalyst, that is, a coking occurs. If the coking occurs, the reforming ability of the reformer catalyst remarkably falls. Therefore, to avoid the coking occurring, the O₂/C molar ratio has to be kept from becoming smaller than 0.5. Further, as will be understood from FIG. 4, in a range where no excess carbon is produced, the amount of generation of hydrogen becomes largest when the O₂/C molar ratio is 0.5. Therefore, in the embodiment of the present invention, when the partial oxidation reforming reaction is performed for generating hydrogen, to avoid the occurrence of the coking and enable hydrogen to be generated most efficiently, the O₂/C molar ratio is in principle made 0.5.

On the other hand, even if the O₂/C molar ratio is made larger than the stoichiometric air-fuel ratio of the O₂/C molar ratio=1.4575, the complete oxidation reaction is performed, but the larger the O₂/C molar ratio becomes, the greater the amount of air to be raised in temperature. Therefore, as shown in FIG. 3, if the O₂/C molar ratio is made greater than the O₂/C molar ratio=1.4575 showing the stoichiometric air-fuel ratio, the larger the O₂/C molar ratio becomes, the more the reaction equilibrium temperature TB will fall. In this case, for example, if the O₂/C molar ratio is made a lean air-fuel ratio of 2.6, when the air temperature is 25° C., the reaction equilibrium temperature TB becomes about 920° C.

Now then, as explained above, at the time of start of operation of the heat and hydrogen generation device 1 shown in FIG. 1, the fuel injected from the burner 7 is ignited by the glow plug 19. Due to this, at the inside of the burner combustion chamber 3, the fuel and air injected from the burner 7 react, whereby burner combustion is started. If the burner combustion is started, the temperature of the reformer catalyst 4 gradually rises. At this time, the burner combustion is performed under a lean air-fuel ratio. Next, if the temperature of the reformer catalyst 4 reaches a temperature able to reform the fuel, the air-fuel ratio is switched from a lean air-fuel ratio to a rich air-fuel ratio and a reforming action of fuel at the reformer catalyst 4 is started. If the reforming action of fuel is started, hydrogen is generated. FIG. 5 shows the temperature distribution inside the oxidizing part 4a and reforming part 4b of the reformer catalyst 4 when the reaction at the reformer catalyst 4 becomes an equilibrium state. Note that, this FIG. 5 shows the temperature distribution in the case where the outside air temperature is 25° C. and this outside air is fed through the low temperature air flow passage 14 shown in FIG. 1 from the burner 7 to the inside of the burner combustion chamber 3.

The solid line of FIG. 5 shows the temperature distribution inside the reformer catalyst 4 when the O₂/C molar ratio of the air and fuel fed from the burner 7 is 0.5. As shown in FIG. 5, in this case, at the oxidizing part 4a of the reformer catalyst 4, the temperature of the reformer catalyst 4 rises toward the downstream side due to the heat of oxidation reaction due to the remaining oxygen. About when the combustion gas proceeds from inside the oxidizing part 4a of the reformer catalyst 4 to the inside of the reforming part 4b, the remaining oxygen in the combustion, gas is consumed and a fuel reforming action is performed at the reforming part 4b of the reformer catalyst 4. This reforming reaction is an endothermic reaction. Therefore, the temperature inside the reformer catalyst 4 falls as the reforming action proceeds, that is, toward, the downstream side of the reformer catalyst 4. The temperature of the downstream side end face of the reformer catalyst 4 at this time is 830° C. and matches the reaction equilibrium temperature TB when the O₂/C molar ratio=0.5 shown in FIG. 3.

On the other hand, FIG. 5 shows by a broken line the temperature distribution inside the reformer catalyst 4 when the O₂/C molar ratio of the air and fuel fed from, the burner 7 is a lean air-fuel ratio of 2.6. In this case as well, the temperature inside the reformer catalyst 4 rises toward the downstream side reformer catalyst 4 due to the heat of oxidation reaction of the fuel inside the oxidizing part 4a of the reformer catalyst 4. On the other hand, in this case, no reforming action is performed inside the reforming part 4b of the reformer catalyst 4, so the temperature of the reformer catalyst 4 is maintained constant in the reforming part 4b. The temperature of the downstream, side end face of the reformer catalyst 4 at this time is 920° C. and matches the reaction equilibrium temperature TB when the O₂/C molar ratio=2.6 shown in FIG. 3. That is, the reaction equilibrium temperature TB of FIG. 3 shows the temperature of the downstream, side end face of the reformer catalyst 4 when the outside air temperature is 25° C. and this outside air is fed through, the low temperature air flow passage 14 shown in FIG. 1 from the burner 7 to the inside of the burner combustion chamber 3.

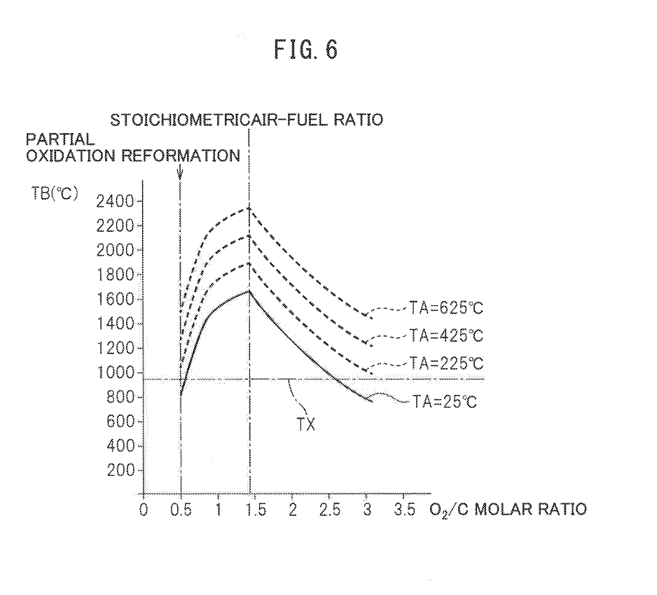

Next, referring to FIG. 6, the reaction equilibrium, temperature TB when changing the temperature of the air reacted, with the fuel at the reformer catalyst will be explained. FIG. 6, in the same way as FIG. 3, shows the relationship between the reaction equilibrium temperature TB when the air and fuel are made to react at the reformer catalyst and reach equilibrium and the O₂/C molar ratio of the air and fuel. Note that, in FIG. 6, TA shows the air temperature. In this FIG. 6, the relationship between the reaction equilibrium temperature TB and the O₂/C molar ratio shown by the solid line in FIG. 3 is shown again by a solid line. FIG. 6 further shows the relationships between the reaction equilibrium temperature TB and the O₂/C molar ratio when changing the air temperature TA to 225° C., 425° C., and 625° C. by broken, lines. From FIG. 6, it will be understood that the reaction, equilibrium temperature TB becomes higher overall regardless of the O₂/C molar ratio if the air temperature TA rises.

On the other hand, it is confirmed that the reformer catalyst 4 used in the embodiment of the present invention does not greatly deteriorate due to heat if the catalyst temperature is 950° C. or less. Therefore, in the embodiment of the present invention, 950° C. is made the allowable catalyst temperature TX enabling heat degradation of the reformer catalyst 4 to be avoided. This allowable catalyst temperature TX is shown in FIG. 3, FIG. 5, and FIG. 6. As will be understood from FIG. 5, when the air temperature TA is 25° C., both when the O₂/C molar ratio is 0.5 or when the O₂/C molar ratio is 2.6, the temperature of the reformer catalyst 4 when the reaction at the reformer catalyst 4 reaches an equilibrium state becomes the allowable catalyst temperature TX or less at all locations of the reformer catalyst 4. Therefore, in this case, it is possible to continue to use the reformer catalyst 4 without being concerned about heat degradation in practice.

On the other hand, as will be understood from FIG. 3, even when the air temperature TA is 25° C., if the O₂/C molar ratio becomes slightly larger than 0.5, the temperature of the downstream side end face of the reformer catalyst 4 when the reaction at the reformer catalyst 4 reaches the equilibrium state, that is, the reaction equilibrium temperature TB, will end up exceeding the allowable catalyst temperature TX. If the O₂/C molar ratio becomes slightly smaller than 2.6, the temperature of the downstream side end face of the reformer catalyst 4 when the reaction at the reformer catalyst 4 reaches the equilibrium state will end up exceeding the allowable catalyst temperature TX. Therefore, for example, when the reaction at the reformer catalyst 4 is in an equilibrium state, if causing a partial oxidation reforming reaction, the O₂/C molar ratio can be made larger than 0.5, but the range by which the O₂/C molar ratio can be enlarged is limited.

On the other hand, as will be understood from FIG. 6, if the air temperature TA becomes higher, when the reaction at the reformer catalyst 4 reaches an equilibrium state, even if making the O₂/C molar ratio 0.5, the temperature of the downstream, side end face of the reformer catalyst 4 when the reaction at the reformer catalyst 4 reaches an equilibrium state will become higher than the allowable catalyst temperature TX and, therefore, the reformer catalyst 4 will deteriorate due to heat. Therefore, when the air temperature TA becomes high, if the reaction at the reformer catalyst 4 becomes an equilibrium state, the O₂/C molar ratio cannot be made 0.5. Therefore, in the embodiment of the present invention, when the reaction at the reformer catalyst 4 reaches an equilibrium state, the air temperature TA is made a low temperature of about 25° C., and the O₂/C molar ratio is made 0.5 in a state maintaining the air temperature TA at about 25° C.

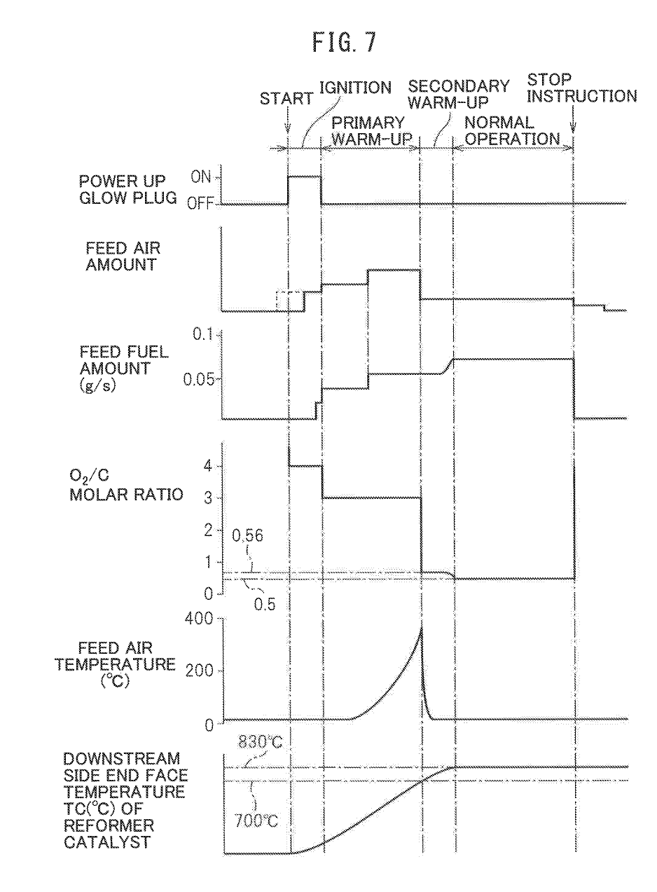

Next, referring to FIG. 7, the method of generation of heat and hydrogen by the heat and hydrogen generation device 1 shown in FIG. 1 will be explained in brief. Note that, FIG. 7 shows the case where the actual O₂/C molar ratio completely coincides with the target O₂/C molar ratio, and, first the method of generation of heat and hydrogen will be explained by focusing on the case where the actual O₂/C molar ratio completely coincides with the target O₂/C molar ratio with reference to FIG. 7 so that the present invention can be easily understood. FIG. 7 shows the operating state of the glow plug 19, the amount of air fed from the burner 7, the amount of fuel injected from the burner 7, the O₂/C molar ratio of the air and fuel to be reacted, the temperature of the air fed from the burner 7, and the temperature TC of the downstream side end face of the reformer catalyst 4. Note that, the various target temperatures for the temperature TC of the downstream side end face of the reformer catalyst 4 shown in FIG. 7 etc., and the various target temperatures for the temperature of the reformer catalyst 4 are theoretical values. In the embodiment according to the present invention, as explained above, for example, the actual equilibrium reaction temperature TB becomes somewhat lower than the target temperature of 830° C. These target temperatures change depending on the structure of the heat and hydrogen generation device 1 etc. Therefore, in actuality, it is necessary to perform experiments to set in advance the optimal target temperatures corresponding to the structure of the heat and hydrogen generation device 1.

If the operation of the heat and hydrogen generation device 1 is started, the glow plug 19 is turned on. Next, the air is fed through the high temperature air flow passage 13 to the inside of the burner combustion chamber 3. In this case, as shown by the broken line in FIG. 7, it is also possible to turn the glow plug 19 on after the air is fed through the high temperature air flow passage 13 to the inside of the burner combustion chamber 3. Next, fuel is injected from the burner 7. If the fuel injected from the burner 7 is ignited by the glow plug 19, the amount of fuel is increased, the O₂/C molar ratio of the air and fuel to be reacted is reduced, from 4.0 to 3.0, and the burner combustion is started at the inside of the burner combustion chamber 3. In the time period, from when the feed of fuel is started to when the fuel is ignited, the air-fuel ratio is made a lean air-fuel ratio so as to suppress as much as possible the amount of generation of HC.

Next, the burner combustion is continued under a lean air-fuel ratio. Due to this, the temperature of the reformer catalyst 4 is made to gradually rise. On the other hand, if the burner combustion is started, the temperature of the gas passing through the reformer catalyst 4 and flowing out into the gas outflow chamber 5 gradually rises. Therefore, the temperature of the air heated at the heat exchange part 13a due to this gas gradually rises. As a result, the temperature of the air fed from the high, temperature air flow passage 13 to the inside of the burner combustion chamber 3 gradually rises. Due to this, warm-up of the reformer catalyst 4 is promoted. The warm-up of the reformer catalyst 4 performed under a lean air-fuel ratio in this way in the embodiment of the present invention, as shown in FIG. 7, is called the “primary warm-up”. Note that, in the example shown in FIG. 7, during this primary warm-up operation, the amount of feed air and the amount of fuel are increased.

This primary warm-up operation is continued until the reforming of the fuel at the reformer catalyst 4 becomes possible. In the embodiment of the present invention, if the temperature of the downstream side end face of the reformer catalyst 4 becomes 700° C., it is judged that reforming of the fuel has become possible at the reformer catalyst 4. Therefore, as shown in FIG. 7, in the embodiment of the present invention, the primary warm-up operation is continued until the temperature TC of the downstream, side end face of the reformer catalyst 4 becomes 700° C. Note that, in the embodiment of the present invention, from the start of operation of the hydrogen generation device 1 to the end of the primary warm-up operation of the reformer catalyst 4, as shown in FIG. 7, the O₂/C molar ratio of the air and fuel to be reacted is made 3.0 to 4.0. Of course, at this time, the temperature of the reformer catalyst 4 is considerably lower than the allowable catalyst temperature TX, so the O₂/C molar ratio of the air and fuel to be reacted can be made an O₂/C molar ratio close to the stoichiometric air-fuel ratio such as 2.0 to 3.0.

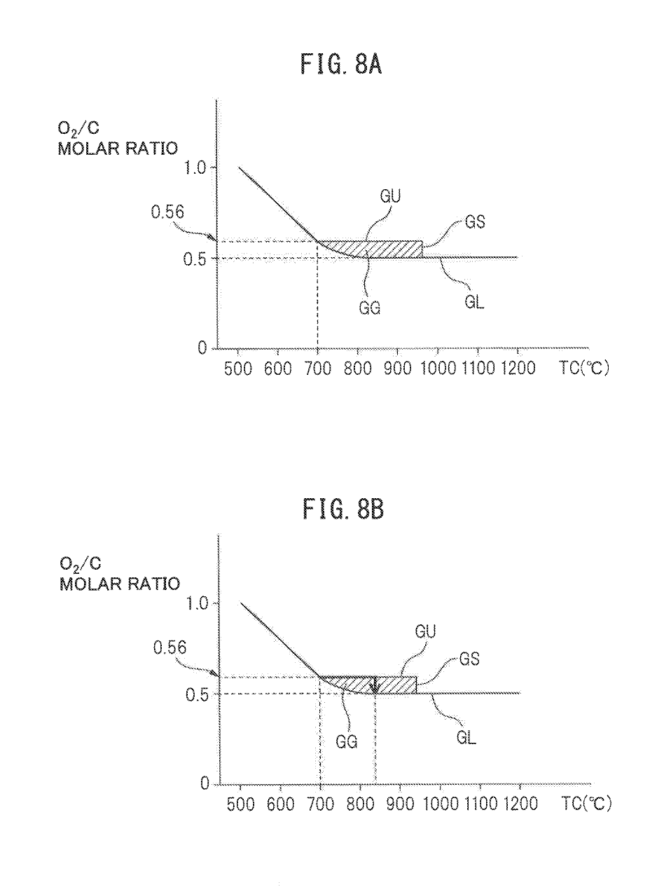

Next, if the temperature TC of the downstream side end face of the reformer catalyst 4 becomes 700° C., it Is judged that reforming of the fuel becomes possible at the reformer catalyst 4, and the partial oxidation reforming reaction for generating hydrogen is started. In the embodiment of the present invention, at this time, as shown, in FIG. 7, first, a secondary warm-up operation is performed, and when the secondary warm-up operation ends, a normal operation is performed. This secondary warm-up operation is performed to further raise the temperature of the reformer catalyst 4 while generating hydrogen. This secondary warm-up operation is continued until the temperature TC of the downstream side end face of the reformer catalyst 4 reaches the reaction equilibrium temperature TB, and when the temperature TC of the downstream side end face of the reformer catalyst 4 reaches the reaction equilibrium temperature TB, the operation is shifted, to the normal operation. In FIG. 8A., the operating region GG of the heat and hydrogen generation device 1 where this secondary warm-up operation is performed is shown by the hatched region surrounded by the solid lines GL, GU, and GS. Note that, in FIG. 8A, the ordinate shows the O₂/C molar ratio of the air and fuel to be reacted while the abscissa, shows the temperature TC of the downstream side end face of the reformer catalyst 4.

As explained with reference to FIG. 4, if the O₂/C molar ratio of the air and fuel to be reacted becomes smaller than 0.5, the coking occurs. The solid line GL in FIG. 8A shows the boundary of the O₂/C molar ratio with respect to occurrence of the coking, and the coking occurs in the region of the O₂/C molar ratio smaller than this boundary GL. Note that, if the temperature of the reformer catalyst 4 becomes lower, even if the O₂/C molar ratio becomes larger, that is, even if the degree of richness of the air-fuel ratio falls, carbon C deposits inside the pores of the substrate of the reformer catalyst without being oxidized and the coking occurs. Therefore, as shown in FIG. 8A, the boundary GL of the O₂/C molar ratio where the coking occurs becomes higher the lower the temperature of the reformer catalyst 4. Therefore, to avoid, the occurrence of the coking, the partial oxidation reforming reaction, that is, the secondary warm-up operation and the normal operation of the heat and hydrogen generation device 1 are performed on the boundary GL of this O₂/C molar ratio or at the upper side of the boundary GL.

On the other hand, in FIG. 8A, the solid line GU shows the upper limit guard value of the O₂/C molar ratio for preventing the temperature of the reformer catalyst 4 from exceeding the allowable catalyst temperature TX at the time of the secondary warm-up operation of the heat and hydrogen generation device 1, while the solid line GS shows the upper limit guard value of the temperature TC of the downstream side end face of the reformer catalyst 4 for preventing the temperature of the reformer catalyst 4 from exceeding the allowable catalyst temperature TX at the time of the secondary warm-up operation of the heat and hydrogen generation, device 1. After the secondary warm-up operation is started, the O₂/C molar ratio is made 0.5. If the temperature TC of the downstream, side end face of the reformer catalyst 4 reaches the reaction equilibrium temperature TB in the O₂/C molar ratio=0.5, the operation is shifted to the normal operation, and hydrogen continues to be generated in the state with the temperature TC of the downstream side end face of the reformer catalyst 4 held at the reaction equilibrium temperature TB.

FIG. 8B shows one example of a secondary warm-up control until shifting to the normal operation. In the example shown in FIG. 8B, as shown by the arrows, if the temperature of the downstream side end face of the reformer catalyst 4 becomes 700° C., to promote the secondary warm-up of the reformer catalyst 4, the partial oxidation reforming reaction is started by the O₂/C molar ratio=0.56. Next, until the temperature TC of the downstream side end face of the reformer catalyst 4 becomes 830° C., the partial oxidation reforming reaction is continued by the O₂/C molar ratio=0.56. Next, if the temperature of the downstream side end face of the reformer catalyst 4 becomes 830° C., the O₂/C molar ratio is reduced until the O₂/C molar ratio=0.5. Next, if the O₂/C molar ratio becomes 0.5, the reforming reaction at the reformer catalyst 4 becomes an equilibrium state. Next, the O₂/C molar ratio is maintained at 0.5 and the operation is shifted to the normal operation.

Now, when in this way the reforming reaction at the reformer catalyst 4 becomes am equilibrium state, if the temperature TA of the air made to react with the fuel is high, as explained referring to FIG. 6, the reaction equilibrium temperature TB becomes higher. As a result, the temperature of the reformer catalyst 4 becomes higher than even the allowable catalyst temperature TX, so the reformer catalyst 4 degrades due to heat. Therefore, in the embodiment of the present invention, when the O₂/C molar ratio is maintained at 0.5 and the reforming reaction at the reformer catalyst 4 becomes an equilibrium state, the feed of high temperature air from the high temperature air flow passage 13 to the inside of the burner combustion chamber 3 is stopped and low temperature air is fed from the low temperature air flow passage 14 to the inside of the burner combustion chamber 3. At this time, the temperature TC of the downstream side end face of the reformer catalyst 4 is maintained at 830° C., therefore, the temperature of the reformer catalyst 4 is maintained, at the allowable catalyst temperature TX or less. Therefore, it is possible to avoid degradation of the reformer catalyst 4 due to heat while generating hydrogen by the partial oxidation reforming reaction.

Note that, when the secondary warm-up operation is being performed in the operating region GG shown in FIGS. 8A and 8B, since the reforming reaction at the reformer catalyst 4 does not become an equilibrium state, even if the air temperature TA is high, the temperature of the reformer catalyst 4 will, not rise as shown, in FIG. 6. However, this secondary warm-up operation is performed in the state where the temperature of the reformer catalyst 4 is high, so there is the danger that for some reason or another, the temperature of the reformer catalyst 4 will end up becoming higher than the allowable catalyst temperature TX. Therefore, in the embodiment of the present invention, to prevent the temperature of the reformer catalyst 4 from becoming higher than the allowable catalyst, temperature TX, at the same time as the secondary warm-up is started, the feed of high pressure air from the high temperature air flow passage 13 to the inside of the burner combustion chamber 3 is stopped and low temperature air is fed from the low temperature air flow passage 14 to the inside of the burner combustion chamber 3. That is, as shown in FIG. 7, the feed air temperature is made to fall. After that, low temperature air continues to be fed from the low temperature air flow passage 14 to the inside of the burner combustion chamber 3 until the normal operation is completed.

As explained above, when the temperature TA of the air made to react with the fuel is 25° C., the equilibrium reaction temperature TB when O₂/C molar ratio=0.5 becomes 830° C. Therefore, generally speaking, when the temperature of the air made to react with the fuel is TA° C., the equilibrium reaction temperature TB when O₂/C molar ratio=0.5 becomes (TA+805° C.). Therefore, in the embodiment of the present invention, when the temperature of the air made to react with the fuel is TA, when the secondary warm-up operation is started, the partial oxidation reforming reaction is continued by the O₂/C molar ratio=0.56 until the temperature TC of the downstream side end face of the reformer catalyst 4 becomes (TA+805° C.). Next, when the temperature TC of the downstream side end face of the reformer catalyst. 4 becomes (TA+805° C.), the O₂/C molar ratio is made to decrease until the O₂/C molar ratio=0.5. Next, if the O₂/C molar ratio becomes 0.5, the O₂/C molar ratio is maintained at 0.5.

Note that, the above mentioned temperature TA of the air made to react with the fuel is the temperature of the air used when calculating the equilibrium reaction temperature TB such as shown in FIG. 3 and the temperature of air not affected by the heat of reaction of burner combustion at the inside of the burner combustion chamber 3. For example, the air fed from the air feed port 11 or the air inside the air chamber 10 is affected by the heat of reaction of the burner combustion and rises in temperature by absorbing the energy of the heat of reaction of the burner combustion. Therefore, the temperature of these air shows the temperature of the air already in the process of reaction, but is not the temperature of the air when calculating the equilibrium reaction temperature TB.

In this regard, the equilibrium reaction temperature TB has to be calculated when the partial oxidation reforming reaction is being performed, that, is, when low temperature air is being fed from the low temperature air flow passage 14 to the inside of the burner combustion chamber 3. Therefore, in the embodiment of the present invention, to detect the temperature of the air not affected by the heat of reaction of burner combustion, at the inside of the burner combustion, chamber 3, the temperature sensor 24 is arranged in the low temperature air flow passage 14 positioned at the outside of the heat insulating material 6 as shown in FIG. 1. The temperature detected by this temperature sensor 24 is used as the temperature TA of the air when calculating the equilibrium reaction temperature TB.

On the other hand, if a stop instruction is issued, the feed of fuel is stopped, as shown in FIG. 7. If the feed of air is stopped at this time, the fuel remaining inside the heat and hydrogen generation device 1 is liable to cause the coking of the reformer catalyst 4. Therefore, in the embodiment of the present invention, to burn off the fuel remaining in the heat and hydrogen generation device 1, air continues to be fed for a while after the stop instruction is issued as shown in FIG. 7.

In this way, in the embodiment of the present invention, to prevent the temperature of the reformer catalyst 4 from becoming higher than the allowable catalyst temperature TX, at the same time as starting the secondary warm-up operation, the feed of high temperature air from the high temperature air flow passage 13 to the inside of the burner combustion chamber 3 is stopped and low temperature air is fed from the low temperature air flow passage 14 to the inside of the burner combustion chamber 3. In other words, at this time, the air flow route for feeding air into the burner combustion chamber 3 is switched from the high temperature air flow route for feeding high temperature air to the low temperature air flow route for feeding low temperature air. To enable the air flow route for feeding air into the burner combustion chamber 3 to be switched between the high temperature air flow route and the low temperature air flow route in this way, in the embodiment of the present invention, a switching device comprised of a high temperature air valve 16 and a low temperature air valve 17 is provided. In this case, in the embodiment of the present invention, the air flow route from the air cleaner 18 through the nigh temperature air flow passage 13 to the air feed port 11 corresponds to the high temperature air flow route, while the air flow route from the air cleaner 18 through the low temperature air flow passage 14 to the air feed, port 11 corresponds to the low temperature air flow route.

Now, as explained above, FIG. 7 shows the case where the actual O₂/C molar ratio matches the target O₂/C molar ratio. In this case, as shown in FIG. 7, at the time of the primary warm-up operation, the target O₂/C molar ratio, that is, the actual O₂/C molar ratio, is maintained at 3.0. At the time of the secondary warm-up operation, the target O₂/C molar ratio, that is, the actual O₂/C molar ratio, is maintained at 0.56, then is made to decrease to 0.5. At the time of normal operation, the target O₂/C molar ratio, that is, the actual O₂/C molar ratio, is maintained at 0.5. In this case, during the time from when the primary warm-up operation is started to when the operation shifts to normal operation, as shown in FIG. 7, the temperature TC of the downstream side end face of the reformer catalyst 4 gradually rises and smoothly reaches the reaction equilibrium, temperature TB, and during the time in which normal operation is performed, the temperature TC of the downstream side end face of the reformer catalyst 4 is maintained at the reaction equilibrium temperature TB. In this case, the reformer catalyst 4 will not coke and will not degrade due to heat.

Further, in the example shown in FIG. 7, at the time of ignition, at the time of the primary warm-up operation, at the time of the secondary warm-up operation, and at the time of normal operation, at each stage, the target amount of feed, of fuel and the target amount of feed of air respectively satisfying the target O₂/C molar ratio and satisfying the quantitative demands demanded at the different, stages are calculated in the electronic control unit 30. On the one hand, a drive signal required for making the amount of feed of fuel this calculated target amount of feed of fuel is supplied to the fuel injector 8, while on the other hand, a drive signal required for making the amount of feed of air this calculated target amount of feed of air is supplied to the air pump 15. In this case, in the embodiment of the present invention, the drive signal required for making the amount of feed of fuel the target amount of feed of fuel, for example, the duty ratio of the opening period of the fuel, injector 8 (ratio of opening period to opening interval) is stored in advance. The fuel injector 8 is driven by the duty ratio stored for the calculated target amount of feed of fuel. On the other hand, the drive signal required for making the amount of feed of air the target amount of feed of air, for example, the drive voltage, is stored in advance. The air pump 15 is driven by the drive voltage stored for the calculated target amount of feed of air.

Note, in the example shown in FIG. 7, for example, the target O₂/C molar ratio is respectively preset for each stage of the time of ignition, the time of the primary warm-up operation, the time of the secondary warm-up operation, and the time of normal operation. In this case, the target amount of feed of fuel and the target amount of feed, of air are respectively preset for the time of ignition and the time of the primary warm-up operation. For the time of the secondary warm-up operation and the time of normal operation, the target amount of feed of fuel corresponding to the demanded output, is calculated and the target amount of feed, of air is calculated based on the calculated target amount of feed, of fuel and the preset target O₂/C molar ratio. Note, if the fuel injector 8 is driven by the duty ratio stored for the calculated target amount of feed of fuel and the air pump 15 is driven by the drive voltage stored for the calculated target amount of feed of air, usually the actual amount of feed of fuel becomes the target amount of feed of fuel, the actual amount of feed of air becomes the target amount of feed of air, and the actual O₂/C molar ratio becomes the target O₂/C molar ratio,

As opposed, to this, for example, if the fuel injection port 9 of the fuel injector 8 becomes clogged, the actual amount of feed of fuel decreases compared with the target amount of feed, of fuel. If the actual amount of feed of fuel is decreased, the actual O₂/C molar ratio becomes larger than the target O₂/C molar ratio. Further, for example, if the air feed port 11 becomes clogged, the actual amount of feed of air decreases compared with the target amount of feed of air. If the actual amount of feed of air decreases, the actual O₂/C molar ratio becomes smaller compared with the target O₂/C molar ratio. That is, in these cases, the actual O₂/C molar ratio deviates from the target O₂/C molar ratio. Further, sometimes, due to some sort of reason, the actual amount of feed of fuel increases compared with the target amount of feed of fuel while sometimes the actual amount of feed of air increases compared with the target amount of feed of air. In these cases as well, the actual O₂/C molar ratio deviates from the target O₂/C molar ratio,

If in this way the actual O₂/C molar ratio deviates from the target O₂/C molar ratio, there is the danger that the reformer catalyst 4 will coke or will degrade due to heat. Therefore, when the actual O₂/C molar ratio deviates from the target O₂/C molar ratio, it is necessary to correct the amount of feed of fuel or the amount of feed of air so that the deviation is eliminated. For this reason, it is necessary to detect that the actual O₂/C molar ratio deviates from the target O₂/C molar ratio. In this case, the O₂/C molar ratio shows the air-fuel ratio, and therefore, if detecting the actual O₂/C molar ratio by using an air-fuel ratio sensor, it is possible to detect that the actual O₂/C molar ratio deviates from the target O₂/C molar ratio. However, O₂/C molar ratio=0.5 corresponds to about air-fuel ratio=5. An air-fuel ratio sensor able to detect that air-fuel ratio=5 is difficult to obtain as a general use product. Even if able to be obtained, it would be extremely expensive.

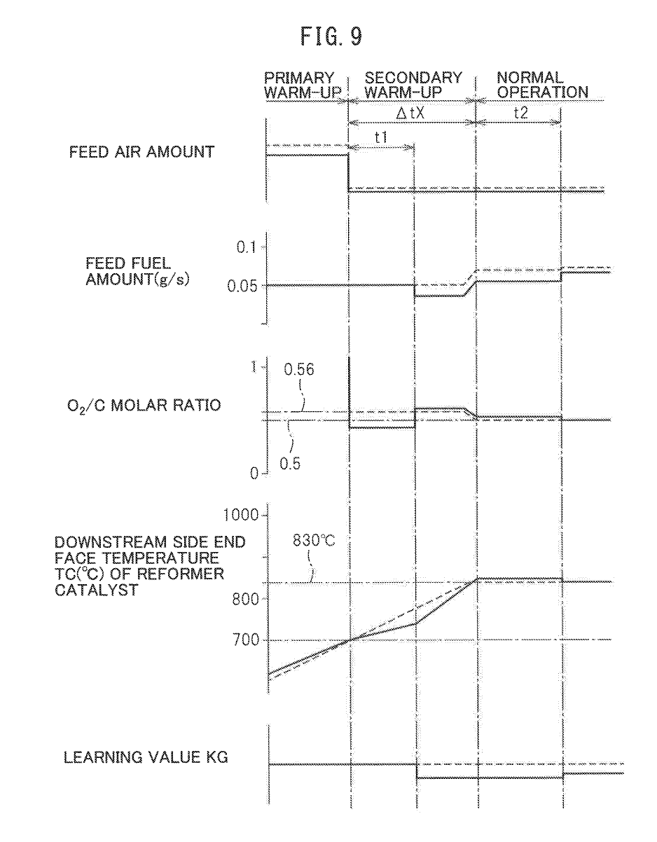

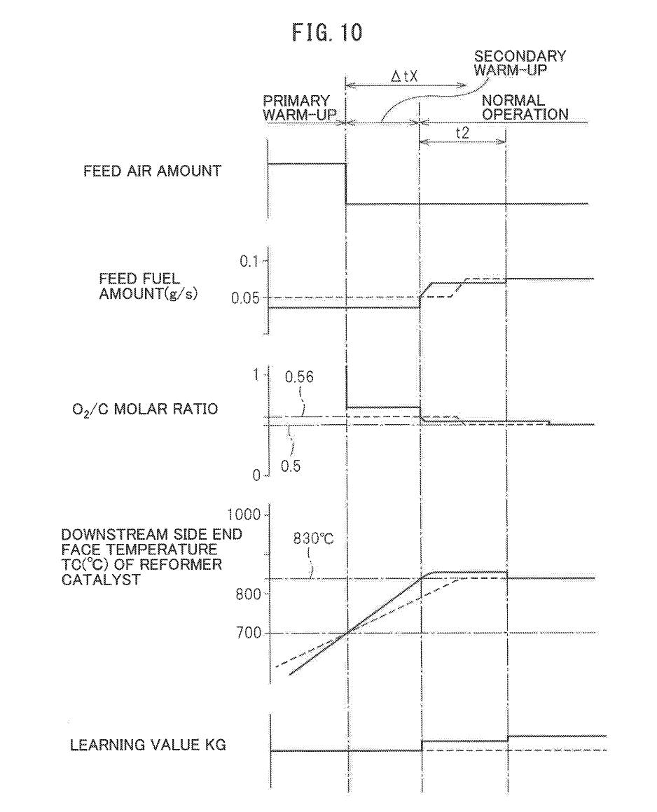

In this regard, however, as understood from FIG. 3, the reaction equilibrium temperature TB changes greatly with respect to a change in the O₂/C molar ratio in particular when the O₂/C molar ratio is near 0.5. Therefore, it is possible to estimate the actual O₂/C molar ratio from the temperature of the reformer catalyst 4. In this case, the temperature sensor is inexpensive. Therefore, estimating the actual O₂/C molar ratio from the temperature of the reformer catalyst 4 detected using a temperature sensor may be considered to be very practical. Therefore, in the embodiment according to the present invention, the actual O₂/C molar ratio is estimated from the temperature of the reformer catalyst 4, and the ratio of feed between the amount of feed of air for burner combustion and the amount of feed of fuel for burner combustion is corrected based on the estimated actual O₂/C molar ratio. In this case, in the example shown in FIG. 9 and FIG. 10, the amount of feed of fuel for burner combustion is corrected based on the estimated actual O₂/C molar ratio and thereby the ratio of feed between the amount of feed of air for burner combustion and the amount of feed of fuel for burner combustion is corrected. Next, this will be explained referring to FIG. 9 and FIG. 10 showing the first embodiment according to the present invention.

FIG. 9 and FIG. 10 show the change of the amount of feed of air from the burner 7, the change of the amount of feed of fuel from the burner 7, the change of the O₂/C molar ratio of the air and fuel which are made to react, the change of the temperature TC of the downstream side end face of the reformer catalyst and the change of the learning value KG for part of the primary warm-up operation and parts of the secondary warm-up operation and normal operation at FIG. 7. Note, in FIG. 9 and FIG. 10, the broken lines show the cases where the actual O₂/C molar ratio, the actual amount of fuel injection, and the actual amount of feed of air respectively match the target O₂/C molar ratio, target amount of fuel injection, and target amount of feed of air, that is, the case shown in FIG. 7. Further, the learning value KG shown in FIG. 9 and FIG. 10 is used for correcting the amount of feed of fuel. If the learning value KG increases, the actual amount of feed of fuel fed from the burner 7 is made to increase from the target amount of feed of fuel QF.

The solid line in FIG. 9 shows the heat and hydrogen generation control in the case where as one example the actual amount of feed of air fed from, the air feed port 11 decreases from the target amount of feed of air for some reason or another. If the actual, amount of feed of air decreases from the target amount of feed of air, at the first half of the secondary warm-up operation of FIG. 9, as shown by the solid line, the actual O₂/C molar ratio becomes smaller than the target O₂/C molar ratio. In this case, while not shown in FIG. 9, even at the time of the primary warm-up operation, the actual O₂/C molar ratio becomes smaller than the target O₂/C molar ratio. If the actual O₂/C molar ratio decreases from the target O₂/C molar ratio, as can be envisioned from FIG. 3, the reaction equilibrium temperature TB where the reformer catalyst 4 becomes an equilibrium state greatly falls.

On the other hand, at the time of the secondary warm-up operation, the temperature TC of the downstream side end face of the reformer catalyst 4 rises toward this reaction equilibrium temperature TB. Therefore, if the reaction, equilibrium temperature TB becomes lower, the rate of rise of the temperature of the reformer catalyst 4 falls. Therefore, the actual O₂/C molar ratio can be estimated from the rate of temperature rise of the reformer catalyst 4 at the time of the secondary warm-up operation. Note, one example of the change of the temperature TC of the downstream side end face of the reformer catalyst 4 when the actual O₂/C molar ratio becomes lower than the target O₂/C molar ratio is shown by the solid line in the first half of the secondary warm-up operation of FIG. 9. As shown by this solid line, when the actual O₂/C molar ratio becomes lower than the target O₂/C molar ratio as well, the rate of temperature rise of the temperature TC of the downstream side end face of the reformer catalyst 4 falls compared with the rate of temperature rise shown by the broken line when, the actual O₂/C molar ratio matches the target O₂/C molar ratio.

On the other hand, if the rate of rise of the temperature of the reformer catalyst 4 falls, the amount of temperature rise of the reformer catalyst 4 at a certain time in the secondary warm-up operation, for example, the amount of temperature rise of the reformer catalyst 4 when a t1 time elapses from when the secondary warm-up operation is started in FIG. 9 also falls. Therefore, it is possible to estimate the actual O₂/C molar ratio from the amount of temperature rise of the reformer catalyst 4 at the time of the secondary warm-up operation. Further, if the rate of temperature rise of the temperature of the reformer catalyst 4 fails, the time required for the reformer catalyst 4 to rise by a constant temperature, that is, the time required for temperature rise of the reformer catalyst 4, becomes longer. Therefore, it becomes possible to estimate the actual O₂/C molar ratio from the time required for temperature rise of the reformer catalyst 4 at the time of the secondary warm-up operation. That is, it becomes possible to estimate the actual O₂/C molar ratio from the rate of temperature rise of the reformer catalyst 4, amount of temperature rise of the reformer catalyst 4, or time required for temperature rise of the reformer catalyst 4 at the time of the secondary warm-up operation.

In this regard, as shown in FIG. 9, if allowing the state where the actual O₂/C molar ratio is lower than the target O₂/C molar ratio to stand, the actual O₂/C molar ratio becomes lower than 0.5 when the temperature TC of the downstream side end face of the reformer catalyst 4 reaches the reaction equilibrium temperature TB or even at the time of the secondary warm-up operation as well. Therefore, there is the danger of coking. Therefore, the state where the actual O₂/C molar ratio is lower than the target O₂/C molar ratio cannot be allowed to stand. Therefore, in the embodiment shown in FIG. 9, the actual O₂/C molar ratio at the time of the secondary warm-up operation is estimated from the rate of temperature rise of the reformer catalyst 4, amount of temperature rise of the reformer catalyst 4, or time required for temperature rise of the reformer catalyst 4 when performing the secondary warm-up operation. When the estimated actual O₂/C molar ratio deviates from the target O₂/C molar ratio, the ratio of feed between the amount of feed of air for burner combustion and the amount, of feed of fuel for burner combustion is corrected in a direction making the estimated actual O₂/C molar ratio approach the target O₂/C molar ratio. Note, in this case, in the example shown in FIG. 9, the amount of feed of fuel for burner combustion is corrected in a direction making the estimated actual O₂/C molar ratio approach the target O₂/C molar ratio.

Specifically speaking, in the example shown in FIG. 9, the rate of temperature rise of the reformer catalyst 4 shown in FIG. 9 by the broken line, that is, the rate of temperature rise of the temperature TC of the downstream side end face of the reformer catalyst 4 when the actual O₂/C molar ratio matches the target O₂/C molar ratio, is preset as the standard rate of temperature rise. At the time of the secondary warm-up operation, when the rate of temperature rise of the reformer catalyst 4 is lower than this preset standard rate of temperature rise, the learning value KG is immediately decreased and thereby the actual amount of feed of fuel QF₀ (=learning value KG·target amount of feed of fuel QF) is immediately decreased, from, the target amount of feed of fuel QF to suppress the occurrence of coking as much as possible.

In this case, in the example shown in FIG. 9, the time period t1 in which it is possible to reliably find the rate of temperature rise of the temperature TC of the downstream side end face of the reformer catalyst 4 in the shortest time after the start of the secondary warm-up operation is preset. In the time period t1 after the start of secondary warm-up operation, when the rate of temperature rise of the reformer catalyst 4 is lower than the preset standard rate of temperature rise, the actual amount of feed of fuel QF₀ is immediately made to decrease from the target amount of feed of fuel QF. Note, in FIG. 9, ΔtX shows the secondary warm-up operation time period when the actual O₂/C molar ratio matches the target O₂/C molar ratio. Therefore, in the example shown in FIG. 9, the time period t1 becomes the first half of the secondary warm-up operation time period ΔtX when the actual O₂/C molar ratio matches the target O₂/C molar ratio. Therefore, in the example shown in FIG. 9, it can be said that in the first half of the secondary warm-up operation time period, when the rate of temperature rise of the reformer catalyst 4 is lower than the preset standard rate of temperature rise, the actual amount of feed of fuel QF₀ immediately is made to decrease from the target amount of feed of fuel QF.

In this case, in the example shown in FIG. 9, the rate of temperature rise ΔTC/t per unit time “t” of the reformer catalyst 4 is found from the amount of temperature rise ΔTC per unit time “t” of the reformer catalyst 4. Then the cumulative value ΣΔTC/t of this rate of temperature rise ΔTC/t in the time period t1 is found, and the rate of temperature rise of the reformer catalyst 4 is found from the average rate (ΣΔTC/t)m of the cumulative value ΣΔTC/t. Note, in this case, it is also possible to find the rate of temperature rise of the reformer catalyst 4 from the amount of temperature rise of the reformer catalyst 4 in the time period t1. Further, in the example shown in FIG. 9, the rate of temperature rise of the reformer catalyst 4 shows the rate of temperature rise of the temperature TC of the downstream side end face of the reformer catalyst 4.

On the other hand, in the example shown in FIG. 9, the learning value KG is set so that the actual O₂/C molar ratio when the normal operation is started becomes 0.5 or more. In this case, it is preferably set so that the actual O₂/C molar ratio when the normal operation is started becomes 0.5, but in this case, there is the danger of the actual O₂/C molar ratio when the normal operation is started becoming lower than 0.5 for some reason or another. Therefore, in the example shown in FIG. 9, the learning value KG is set so that the actual O₂/C molar ratio when the normal operation is started becomes somewhat higher than 0.5. In this case, in the example shown in FIG. 9, the learning value KG is calculated from the rate of temperature rise of the reformer catalyst 4 shown by the solid line in the first half of the secondary warm-up operation time period and the rate of temperature rise of the reformer catalyst 4 at the time of the secondary warm-up operation shown by the broken line.

That is, the slower the rate of temperature rise of the reformer catalyst 4 shown by the solid line in the first half of the secondary warm-up operation time period compared with the rate of temperature rise of the reformer catalyst 4 at the time of the secondary warm-up operation shown by the broken line, the more necessary it is to raise the rate of temperature rise of the reformer catalyst 4 in the second half of the secondary warm-up operation time period. Therefore, in the example shown in FIG. 9, the learning value KG is multiplied with the constant C1·(rate of temperature rise of reformer catalyst 4 at time of secondary warm-up operation shown by broken line)/(rate of temperature rise of reformer catalyst 4 shown by solid line in first half of secondary warm-up operation time period) to find the new learning value KG. In this case, if making the rate of temperature rise of the reformer catalyst 4 shown by the solid line in the first half of the secondary warm-up operation time period the average rate (ΣΔTC/t)m of the above cumulative value ΣΔTC/t of the rate of temperature rise and making the rate of temperature rise of the reformer catalyst 4 at the time of secondary warm-up operation shown by the broken line TCX, the new learning value KG is expressed by KG·C1·TCX/(ΣΔTC/t)m.

Of course, in this case, it is possible to find the optimum learning value KG corresponding to the magnitude of the rate of temperature rise of the reformer catalyst 4 shown by the solid line in the first half of the secondary warm-up operation time period in advance by experiments, store the optimum learning value KG found by experiments in the ROM 32, and use the learning value stored in advance corresponding to the magnitude of the rate of temperature rise of the reformer catalyst 4 shown by the solid line in the first half of the secondary warm-up operation time period as the learning value KG. Note, at the time of warm-up operation, even if the actual O₂/C molar ratio were maintained the same, if the actual amount of feed of fuel and the actual amount of feed of air respectively are increased or decreased from the target amount of feed of fuel and the target amount of feed, of air, the rate of temperature rise of the reformer catalyst 4 changes along with this. However, the amount of change of the rate of temperature rise of the reformer catalyst 4 when the actual amount of feed of fuel and the actual amount of feed, of air change is small, so in the example shown in FIG. 9, the change of the rate of temperature rise of the reformer catalyst 4 when the actual amount of feed of fuel and the actual amount of feed of air change is removed from consideration.

On the other hand, the solid line of FIG. 10 shows, as one example, the heat and hydrogen generation control when the actual amount of feed of fuel fed from the fuel injector 8 is decreased from the target amount of feed, of fuel for some reason or another. If the actual amount of feed, of fuel decreases from the target amount of feed of fuel, at the time of the secondary warm-up operation of FIG. 10, as shown by the solid line, the actual O₂/C molar ratio becomes larger than the target O₂/C molar ratio. If the actual O₂/C molar ratio becomes larger than the target O₂/C molar ratio, as will be understood from FIG. 3, the reaction equilibrium temperature TB when the reformer catalyst 4 becomes the equilibrium state becomes much higher.

On the other hand, as explained above, at the time of the secondary warm-up operation, the temperature TC of the downstream side end face of the reformer catalyst 4 rises toward, this reaction equilibrium temperature TB. Therefore, if the reaction equilibrium temperature TB rises, the rate of temperature rise of the reformer catalyst 4 increases. Note, one example of the change of the temperature TC of the downstream side end-face of the reformer catalyst 4 when the actual O₂/C molar ratio becomes higher than the target O₂/C molar ratio is shown by the solid line at the time of the secondary warm-up operation of FIG. 10. As shown by this solid line, when the actual O₂/C molar ratio becomes higher than the target O₂/C molar ratio, the rate of temperature rise of the temperature TC of the downstream side end face of the reformer catalyst 4 increases compared, with the rate of temperature rise shown by the broken line when the actual O₂/C molar ratio matches the target O₂/C molar ratio.

On the other hand, if the rate of temperature rise of the temperature of the reformer catalyst 4 increases, the amount of temperature rise of the reformer catalyst 4 at a certain time during the secondary warm-up operation also increases. Therefore, it becomes possible to estimate the actual O₂/C molar ratio from the amount of temperature rise of the reformer catalyst 4 at the time of the secondary warm-up operation as well. Further, if the rate of temperature rise of the reformer catalyst 4 increases, the time required for the reformer catalyst 4 to rise by a certain temperature, that is, the time required for temperature rise of the reformer catalyst 4, becomes shorter. Therefore, it becomes possible to estimate the actual O₂/C molar ratio from the time required for temperature rise of the reformer catalyst 4 at the time of the secondary warm-up operation. That is, as explained above, it becomes possible to estimate the actual O₂/C molar ratio from the rate of temperature rise of the reformer catalyst 4, amount of temperature rise of the reformer catalyst 4, or time required for temperature rise of the reformer catalyst 4 at the time of the secondary warm-up operation.

In this regard, as shown in FIG. 10, if allowing the state where the actual O₂/C molar ratio is higher than the target O₂/C molar ratio to stand, the temperature of the reformer catalyst 4 rises to an allowable catalyst temperature TX enabling heat degradation of the reformer catalyst 4 to be avoided. As a result, there is the danger of the reformer catalyst 4 degrading due to heat. Therefore, it is not possible to allow the state where the actual O₂/C molar ratio is higher than the target O₂/C molar ratio to stand. Therefore, in the embodiment shown in FIG. 10 as well, in the same way as the embodiment shown in FIG. 9, the actual O₂/C molar ratio at the time of the secondary warm-up operation is estimated from the rate of temperature rise of the reformer catalyst 4, amount of temperature rise of the reformer catalyst 4, or time required for temperature rise of the reformer catalyst 4 when performing the secondary warm-up operation. When the estimated actual O₂/C molar ratio deviates from the target O₂/C molar ratio, the ratio of feed between the amount of feed of air for burner combustion and the amount of feed of fuel for burner combustion is corrected in a direction making the estimated actual O₂/C molar ratio approach the target O₂/C molar ratio. Note, in this case, in the example shown in FIG. 10 as well, the amount of feed of fuel for burner combustion is corrected in a direction making the estimated actual O₂/C molar ratio approach the target O₂/C molar ratio.

Specifically speaking, in the example shown in FIG. 10, the rate of temperature rise shown by the broken line in FIG. 10, that is, rate of temperature rise of the temperature TC of the downstream side end face of the reformer catalyst 4 when the actual O₂/C molar ratio matches the target O₂/C molar ratio, is preset as the standard rate of temperature rise. When, at the time of the secondary warm-up operation, the rate of temperature rise of the reformer catalyst 4 is higher than this preset standard rate of temperature rise, to prevent the reformer catalyst 4 from, heat degradation, when shifting to normal operation, the learning value KG is immediately increased. Due to this, the actual amount, of feed of fuel QF₀ (=learning value KG·target amount of feed of fuel QF) is made to immediately increase from the target amount of feed of fuel QF.

On the other hand, in FIG. 9 and FIG. 10, ΔtX expresses the secondary warm-up operation time period during which, the secondary warm-up operation is performed when the actual O₂/C molar ratio matches the target O₂/C molar ratio. The secondary warm-up operation is started when the temperature TC of the downstream side end face of the reformer catalyst 4 is 700° C. and is made to end when the temperature TC of the downstream side end face of the reformer catalyst 4 reaches 830° C. and then the actual O₂/C molar ratio is made 0.5. Note, as explained above, when the air temperature is TA° C., the reaction equilibrium temperature TB when O₂/C molar ratio=0.5 becomes (TA+805° C.). Therefore, when the air temperature is TA° C., the secondary warm-up operation is made to end when the temperature TC of the downstream side end face of the reformer catalyst 4 reaches (TA+805° C.) and then the actual O₂/C molar ratio is made 0.5. Therefore, the secondary warm-up operation time period ΔtX becomes a function of the air temperature TA. This secondary warm-up operation time period ΔtX is stored as a function of the air temperature TA in advance inside the ROM 32,

Now then, as explained above, when the actual O₂/C molar ratio becomes higher than the target O₂/C molar ratio, at the time of the secondary warm-up operation of FIG. 10, as shown by the solid line, the rate of temperature rise of the temperature TC of the downstream side end face of the reformer catalyst 4 increases compared with the rate of temperature rise shown by the broken line when the actual O₂/C molar ratio matches the target O₂/C molar ratio. Therefore, as shown in FIG. 10, the secondary warm-up operation time period Σt when the actual O₂/C molar ratio becomes higher than the target O₂/C molar ratio becomes shorter compared with the secondary warm-up operation time period ΔtX when the actual O₂/C molar ratio matches the target O₂/C molar ratio. That is, the time Σt required for temperature rise of the reformer catalyst 4 when the actual O₂/C molar ratio becomes higher than the target O₂/C molar ratio becomes shorter compared with the time ΔtX required for temperature rise of the reformer catalyst 4 when the actual O₂/C molar ratio matches the target. O₂/C molar ratio.

On the other hand, in the example shown in FIG. 10 as well, the learning value KG is set so that the actual O₂/C molar ratio when normal operation is started becomes 0.5 or more. That is, as explained above, in this case, it is preferably set so that the actual O₂/C molar ratio when normal operation is started becomes 0.5. In this case as well, there is the danger that the actual O₂/C molar ratio when normal operation is started will become lower than 0.5 for some reason or another. Therefore, in the example shown in FIG. 10, the learning value KG is set so that the actual O₂/C molar ratio when normal operation is started becomes somewhat higher than 0.5. In this case, in the example shown in FIG. 10, the learning value KG is calculated from the secondary warm-up operation time period Σt and the secondary warm-up operation time period ΔtX.

That is, the raster the rate of temperature rise of the reformer catalyst 4 shown by the solid line in the first half of the secondary warm-up operation time period compared, with the rate of temperature rise of the reformer catalyst 4 at the time of the secondary warm-up operation shown by the broken line, the more necessary it is to increase the amount of fuel injection from the fuel injector 8 at the time of shifting to normal operation to make the actual O₂/C molar ratio drop and thereby make the temperature of the reformer catalyst 4 drop. Therefore, in the example shown in FIG. 10, the learning value KG is multiplied with, the constant C2·(secondary warm-up operation time period ΔtX/secondary warm-up operation time period Σt) to find a new learning value KG. In this case as well, it is possible to find the optimum learning value KG corresponding to the secondary warm-up operation time period Σt in advance by experiments, store the optimum, learning value KG found by experiments in the ROM 32, and use the learning value stored in advance corresponding to the magnitude of the secondary warm-up operation time period Σt as the learning value KG.

On the other hand, in this embodiment according to the present invention, the learning value KG is corrected when a predetermined certain time t2 elapses after shifting to normal operation. That is, when, at this time, the temperature TC of the downstream side end face of the reformer catalyst 4 is not the reaction equilibrium temperature TB, the actual O₂/C molar ratio deviates from the target O₂/C molar ratio=0.5. At this time, if using the relationship shown in FIG. 3, the amount of deviation of the actual O₂/C molar ratio from the target. O₂/C molar ratio can be learned from the temperature difference of the temperature TC of the downstream side end face of the reformer catalyst 4 and the reaction equilibrium temperature (TA+805° C.). If the amount of deviation of the actual O₂/C molar ratio from the target O₂/C molar ratio can be learned, the amount of correction of the learning value KG required for making the actual O₂/C molar ratio the target O₂/C molar ratio can be learned. In this way, the learning value KG is corrected.

Giving one example, when a predetermined certain time t2 elapses after shifting to normal operation, the learning value KG is not updated when the temperature TC of the downstream side end face of the reformer catalyst 4 is between (TA+805° C.) and (TA+805° C.)+α (α is a small constant value). As opposed to this, if the temperature TC of the downstream, side end face of the reformer catalyst 4 becomes higher than (TA+805° C.)+α, the learning value KG is increased by C3 (constant)·(TC−(TA+805° C.+α)) whereby the amount of fuel injection from the fuel injector 8 is increased. On the other hand, if the temperature TC of the downstream side end face of the reformer catalyst 4 becomes lower than (TA+805° C.), the learning value KG is decreased by C3 (constant)·((TA+805° C.)−TC) whereby the amount of fuel injection from the fuel injector 8 is decreased. Note, in this embodiment according to the present invention, at normal operation, this action of updating the learning value KG is performed every fixed time t2.

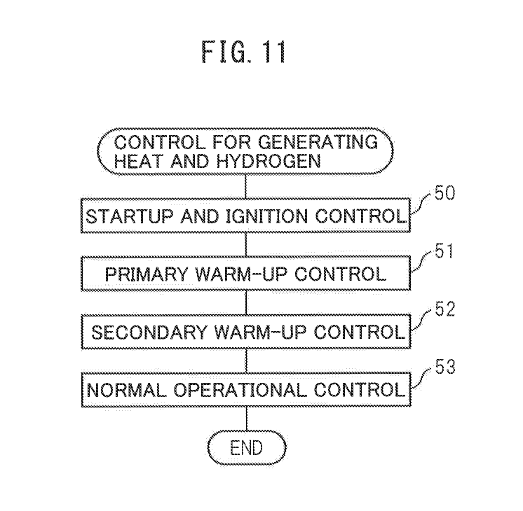

FIG. 11 to FIG. 19 show the heat and hydrogen generation control routine for working the first embodiment, according to the present invention explained while referring to FIG. 9 and FIG. 10. This heat and hydrogen generation control routine is performed by an instruction for starting heat and hydrogen generation control being issued at the instruction generating part 39 shown, in FIG. 1. In this case, for example, the instruction for starting this heat and hydrogen generation control is issued when the startup switch of the heat and hydrogen generation device 1 is turned on. Further, when, the heat and hydrogen generation device 1 is used, for warming up an exhaust purification catalyst of a vehicle, this instruction for starting this heat and hydrogen generation control is issued when the ignition switch is turned on.

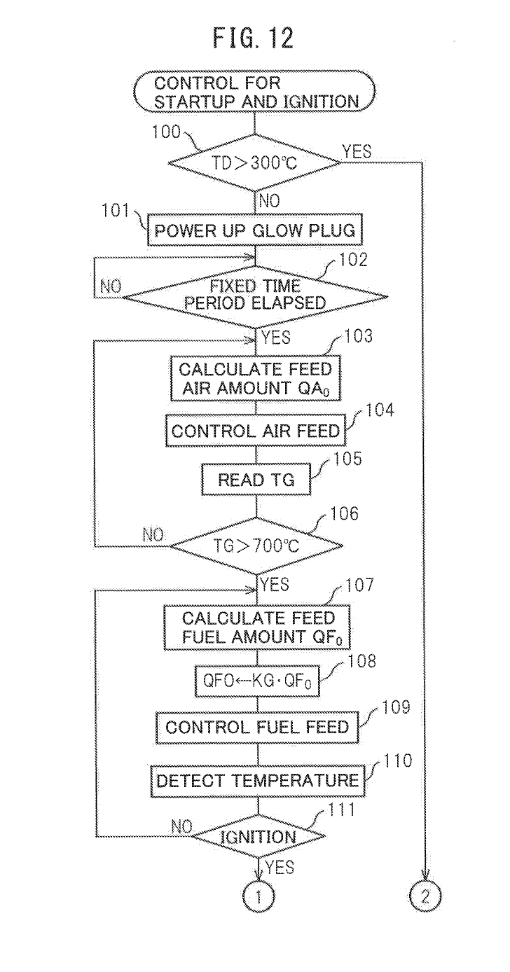

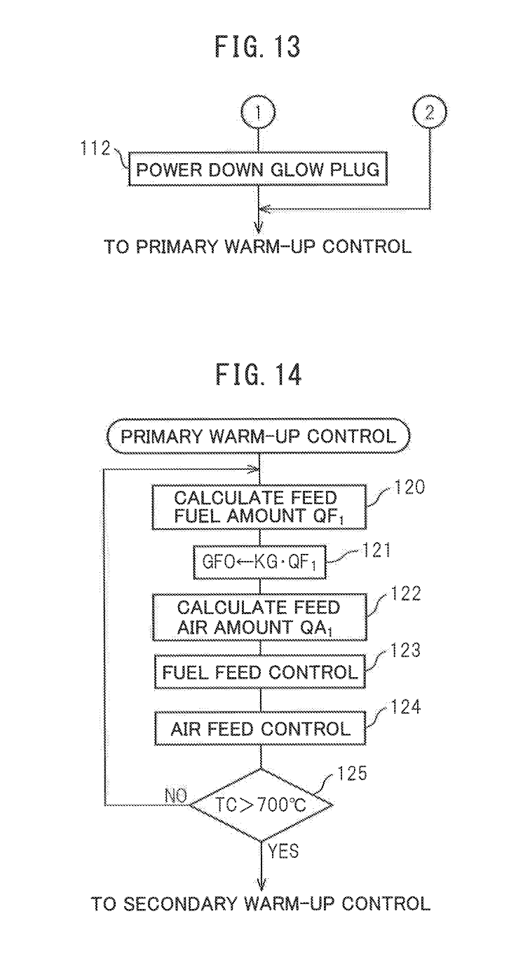

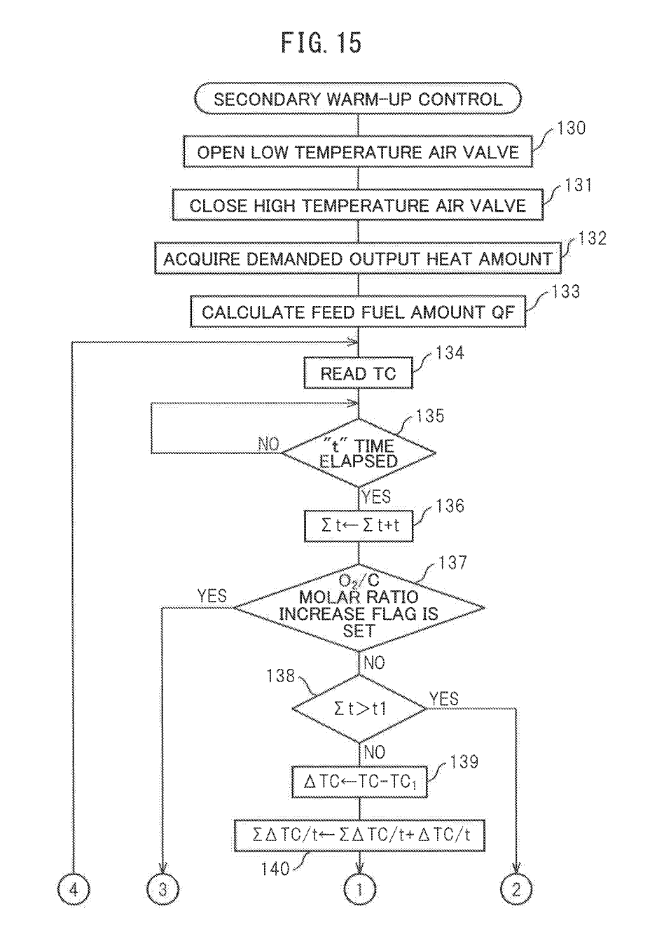

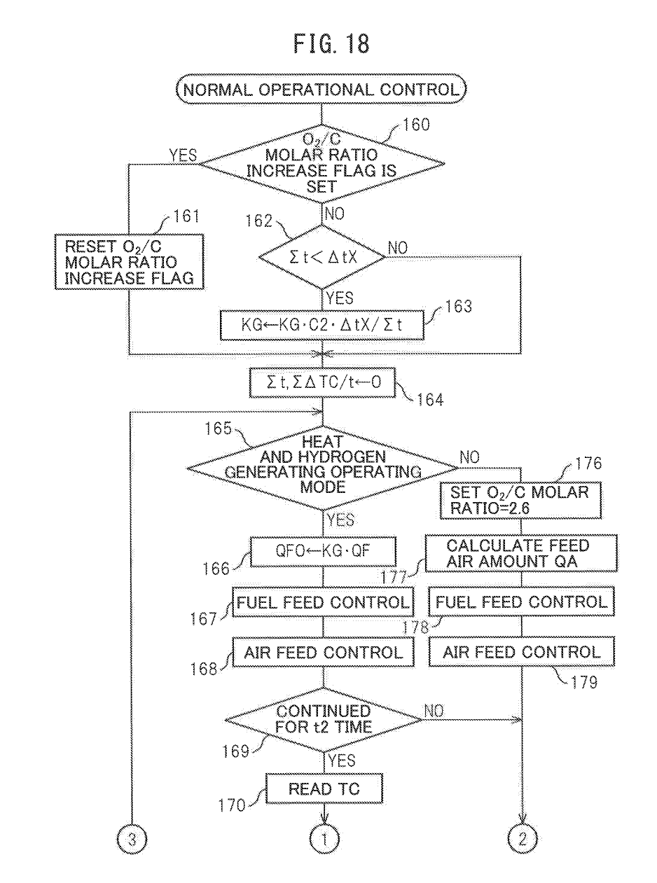

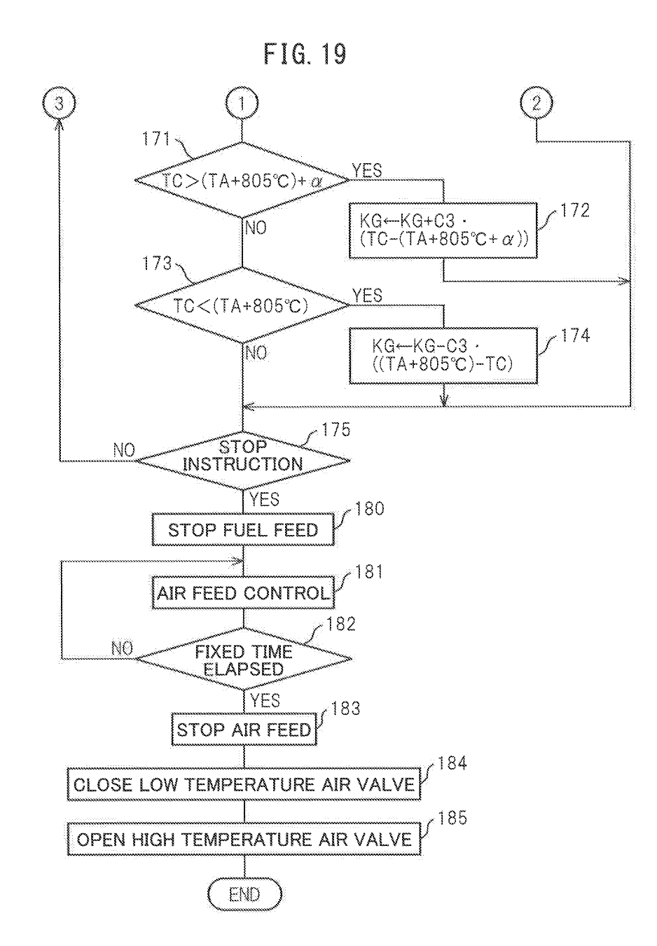

As shown in FIG. 11, if the heat and hydrogen generation control routine is performed, first, at step 50, the startup and ignition control of the heat and hydrogen generation device 1 is performed. This startup and ignition control routine is shown FIG. 12 and FIG. 13. If the startup and ignition control of the heat, and hydrogen generation device 1 ends, the routine proceeds to step 51 where the primary warm-up control of the heat and hydrogen generation device 1 is performed. This primary warm-up control routine is shown in FIG. 14. If the primary warm-up ends, the routine proceeds to step 52 where the secondary warm-up control of the heat and hydrogen generation device 1 is performed. This secondary warm-up control routine is shown in FIG. 15 to FIG. 17. If the secondary warm-up ends, the routine proceeds to step 53 where the normal operational control of the heat and hydrogen generation device 1 is performed. This normal operational control routine is shown in FIG. 18 and FIG. 19.

Now then, if referring to the startup and ignition control routine shown in FIG. 12, first, at step 100, it is judged based on the output signal of the temperature sensor 22 if the temperature TD of the upstream side end face of the reformer catalyst 4 is a temperature where an oxidation reaction can be performed at the upstream side end face of the reformer catalyst 4, for example, greater than 300° C. If the temperature TD of the upstream side end face of the reformer catalyst 4 is 300° C. or less, the routine proceeds to step 101 where the glow plug 19 is turned on. Next, at step 102, it is judged, if a fixed time has elapsed from when the glow plug 19 is turned on. When the fixed time has elapsed, the routine proceeds to step 103.

At step 103, the target amount of feed of air QA₀ at the time of startup and ignition is calculated. This target amount of feed of air QA₀ is stored in advance in the ROM 32. Next, at step 104, the pump drive power required, for making the air pump 15 discharge this target amount of feed of air QA₀ is supplied to the air pump 15, and air is discharged from the air pump 15 by a target amount of feed of air QA₀. At this time, the air discharged from the air pump 15 is fed through the high temperature air flow route 13 to the burner combustion chamber 3. Note, when operation of the heat and hydrogen generation device 1 is stopped, the high temperature air valve 16 is opened and the low temperature air valve 17 is closed. Therefore, when the heat and hydrogen generation device 1 is made to operate, air is fed through the high temperature air flow route 13 to the burner combustion chamber 3.

Next, at step 105, the temperature TG of the glow plug 19 is calculated from the resistance value of the glow plug 19. Next, at step 106, it is judged if the temperature TG of the glow plug 19 exceeds 700° C. When it is judged that the temperature TG of the glow plug 19 does not exceed 700° C., the routine returns to step 103. As opposed to this, when it is judged that the temperature TG of the glow plug 19 exceeds 700° C., it is judged that ignition is possible and the routine proceeds to step 107.

At step 107, the target amount of feed of fuel QF₀ at the time of startup and ignition, is calculated. This target amount of feed of fuel QF₀ is stored in advance in the ROM 32. Next, at step 108, this target amount of feed of fuel QF₀ is multiplied with the learning value KG, and thereby the final amount of feed of fuel QF₀ (=KG·QF₀) is calculated. Next, at step 109, fuel is fed from the fuel injector 8 to the burner combustion chamber 3 by the final amount of feed of fuel QF₀. Next, at step 110, the temperature TD of the upstream side end face of the reformer catalyst 4 is detected based on the output signal of the temperature sensor 22. Next, at step 111, it is judged from the output signal of the temperature sensor 22 if the fuel has been ignited. If the fuel has been ignited, the temperature TD of the upstream side end face of the reformer catalyst 4 instantaneously rises. Therefore, it is possible to judge from the output signal of the temperature sensor 22 if the fuel has been ignited.

When at step 111 it is judged that the fuel has not been ignited, the routine returns to step 107, while when at step 111 it is judged that the fuel has been ignited, the routine proceeds to step 112 where the glow plug 19 is turned off. Next, the routine proceeds to step 51 of FIG. 11 where the primary warm-up control is performed. Note, if the fuel is ignited, the temperature TD of the upstream side end face of the reformer catalyst 4 immediately becomes a temperature where an oxidation reaction can be performed on the upstream side end face of the reformer catalyst 4, for example, 300° C. or more. On the other hand, when at step 100 it is judged that the temperature TD of the upstream side end face of the reformer catalyst 4 is 300° C. or more, the routine immediately proceeds to step 51 of FIG. 11 where the primary warm-up control is performed.

Next, the primary warm-up control performed at step 51 of FIG. 11 will be explained with reference to FIG. 14. Referring to FIG. 14, first, at step 120, the target amount of feed of fuel QF₁ at the time of the primary warm-up operation is calculated. This target amount of feed of fuel QF₁ is stored in advance in the ROM 32. Next, at step 121, this target amount of feed of fuel QF₁ is multiplied with the learning value KG and thereby the final amount of feed of fuel QF₀ (=KG·QF₁) is calculated. Next, at step 122, the target amount of feed of air QA₁ is calculated from the target amount of feed of fuel QF₁ and the target O₂/C molar ratio. Note, as shown in FIG. 7, at this time, the target O₂/C molar ratio is made 3.0. Next, at step 123, fuel is fed from the fuel injector 8 to the burner combustion chamber 3 by the final amount of feed of fuel QF₀ calculated at step 121. Next, at step 124, the pump drive power required for making the target amount of feed of air QA₁ calculated at step 122 be discharged from the air pump 15 is supplied, to the air pump 15, then air is discharged from the air pump 15 by the target amount of feed of air QA₁.

At this time, that is, at the time of the primary warm-up operation, the air discharged from the air pump 15 is fed through the high temperature air flow route 13 to the burner combustion chamber 3. Note that, in the embodiment of the present invention, when this primary warm-up operation is performed, as shown in FIG. 7, the amount of feed of air and the amount of feed of fuel are increased in stages. Next, at step 125, it is judged if the temperature TC of the downstream side end face of the reformer catalyst 4 exceeds 700° C. based on the output signal of the temperature sensor 23. When it is judged that the temperature TC of the downstream side end face of the reformer catalyst 4 does not exceed 700° C., the routine returns to step 120 where the primary warm-up operation is continued. As opposed to this, when it is judged that the temperature TC of the downstream side end face of the reformer catalyst 4 exceeds 700° C., the routine proceeds to step 52 shown in FIG. 11 where the secondary warm-up control, that is, a partial, oxidation reforming reaction, is started.

Next, the secondary warm-up control performed at step 52 of FIG. 11 will be explained while referring to FIG. 15 to FIG. 17. If the secondary warm-up control, that is, a partial oxidation reforming reaction, is started, as shown in FIG. 15, first, at step 130, the low temperature air valve 17 is opened, then, at step 131, the high temperature air valve 16 is closed. Therefore, at this time, air is fed through the low temperature air flow route 14 to the burner combustion chamber 3. Next, at step 132, the demanded value of the amount of output heat (kW) is acquired. For example, when the heat and hydrogen generation device 1 is used for warming up an exhaust purification catalyst of a vehicle, the demanded value of this amount of output heat is made the amount of heat required for making an exhaust purification catalyst rise to an activation temperature. Next, at step 133, the amount of feed of fuel QF required for generating the demanded amount of output heat of this amount of output heat (kW) is calculated. Next, the routine proceeds to step 134.

At step 134 to step 146, the updating control of the learning value KG is performed. That, is, at step 134, the temperature TC of the downstream side end face of the reformer catalyst 4 is read. Next, at step 135, it is judged if a fixed time “t” has elapsed. If the fixed time “t” has elapsed, the routine proceeds to step 136 where this fixed time “t” is added, to Σt. Therefore, this Σt expresses the elapsed time from, when the processing routine proceeds from step 133 to step 134. Next, at step 137, it is judged if the O₂/C molar ratio increase flag, which is set when the O₂/C molar ratio should be increased, is set. When, the O₂/C molar ratio increase flag is not set, the routine proceeds to step 138 where it is judged if the elapsed time Σt exceeds the preset time t1 as shown in FIG. 9. As will be understood from FIG. 9, this preset time t1 corresponds to the first half of the secondary warm-up operation time period.

When at step 138 it is judged that the elapsed time Σt does not exceeds the preset time t1, the routine proceeds to step 139 where the temperature difference between the currently read temperature TC of the downstream side end face of the reformer catalyst 4 and the previously read temperature TC₁ of the downstream side end face of the reformer catalyst 4, that is, the amount of temperature rise ΔTC (=TC−TC₁) of the temperature TC of the downstream side end face of the reformer catalyst 4 in the fixed time “t”, is calculated. Next, at step 140, the value obtained by dividing this amount of temperature rise ΔTC by the fixed time “t”, that is, the rate of temperature rise ΔTC/t is added to ΣΔTC/t and thereby the cumulative value ΣΔTC/t of the rate of temperature rise is calculated.

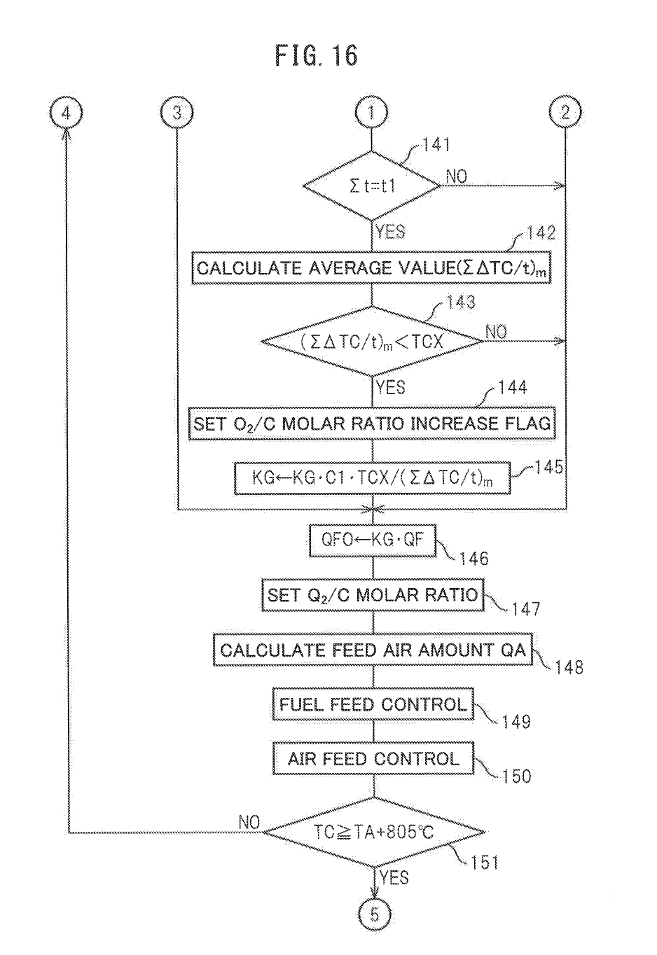

Next, at step 141 of FIG. 16, it is judged if the elapsed time Σt becomes the preset time t1 shown in FIG. 9. When it is judged that the elapsed time Σt becomes the preset time t1, that is, when the preset time t1 has elapsed from when the secondary warm-up operation was started, the routine proceeds to step 142 where the cumulative value ΣΔTC/t of the rate of temperature rise is divided by the number of times of cumulative addition and thereby the average value (ΣΔTC/t)m of the cumulative value ΣΔTC/t of the rate of temperature rise is calculated. In the example shown in FIG. 9, this average rate (ΣΔTC/t)m is made the rate of temperature rise of the reformer catalyst 4 at the first half of the secondary warm-up operation time period.

Next, at step 143, it is judged if this average rate (ΣΔTC/t)m is smaller than the rate of temperature rise TCX of the reformer catalyst 4 at the time of the secondary warm-up operation shown by the broken line in FIG. 9. When the average rate (ΣΔTC/t)m is smaller than the rate of temperature rise TCX of the reformer catalyst 4 at the time of the secondary warm-up operation shown by the broken line in FIG. 9, the routine proceeds to step 144 where the O₂/C molar ratio increase flag is set, and, next, at step 145, the new learning value KG (=KG·C1·TCM/(ΣΔTC/t)m) is calculated. Next, at step 146, the target amount of feed of fuel QF calculated at step 133 is multiplied with the learning value KG and thereby the final amount of feed of fuel QF₀ (=KG·QF) is calculated. Note, once the O₂/C molar ratio increase flag is set, the routine jumps from step 137 to step 146. Further, when at step 138 it is judged that the elapsed, time Σt exceeds the preset time t1 and when at step 141 it is judged that the elapsed time Σt is not the preset time t1, the routine jumps to step 146.

Next, at step 147, the target O₂/C molar ratio at the time of the secondary warm-up operation, is set. In the embodiment of the present invention, this target O₂/C molar ratio is made 0.56. Next, at step 148, the target amount of feed of air QA is calculated from the target amount of feed of fuel QF and the target O₂/C molar ratio. Next, at step 149, fuel is fed from the fuel injector 8 to the burner combustion chamber 3 by the final amount of feed of fuel QF₀ calculated at step 146. Next, at step 150, the pump drive power required for making the target amount of feed of air QA calculated at step 148 be discharged from the air pump 15 is supplied to the air pump 15, then air is discharged from the air pump 15 by the target amount of feed of air QA.

At this time, a partial oxidation reforming reaction is performed and hydrogen is generated. Next, at step 151, it is judged if the temperature TC of the downstream side end face of the reformer catalyst 4 reaches the sum (TA+805° C.) of the air temperature TA detected by the temperature sensor 24 and 805° C. As explained above, this temperature (TA+805° C.) shows the reaction equilibrium temperature TB when a partial oxidation reforming reaction is performed by an O₂/C molar ratio=0.5 when the air temperature is TA° C. Therefore, at step 151, it is judged if the temperature TC of the downstream side end face of the reformer catalyst 4 reaches the reaction equilibrium temperature (TA+805° C.). When it is judged that the temperature TC of the downstream side end face of the reformer catalyst 4 does not reach the reaction equilibrium temperature (TA+805° C.), the routine returns to step 134.

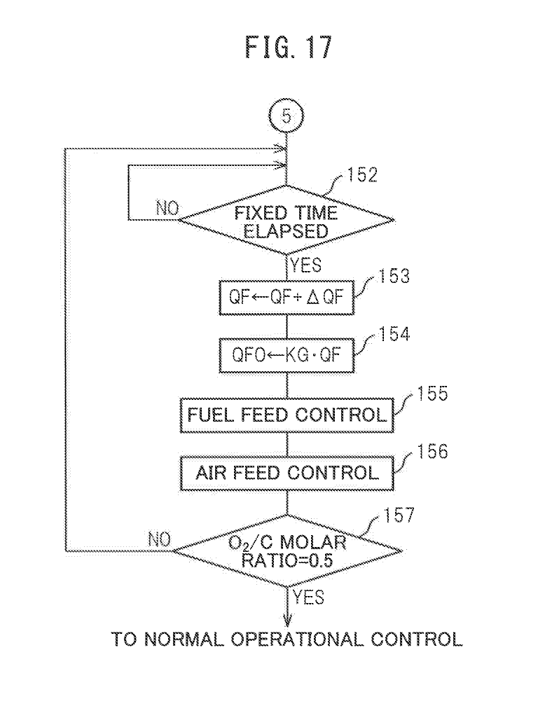

As opposed to this, when at step 151 it is judged that the temperature TC of the downstream side end face of the reformer catalyst 4 reaches the reaction equilibrium temperature (TA+805° C.), the routine proceeds to step 152 of FIG. 17. At step 152 to step 157, the amount of feed of fuel is gradually increased in the state maintaining the amount of discharge of the air pump 15 constant until the target O₂/C molar ratio becomes 0.5 and thus the target O₂/C molar ratio is made to gradually decrease. That is, at step 152, it is judged if a fixed time has elapsed. When the fixed time has elapsed, the routine proceeds to step 153. That is, the routine proceeds to step 153 every time the fixed time elapses. At step 153, the target amount of feed of fuel QF is increased by exactly a small constant value ΔQF. Next, at step 154, the target amount of feed of fuel QF calculated at step 153 is multiplied, with the learning value KG and thereby the final amount of feed, of fuel QF₀ (=KG·QF) is calculated.

Next, at step 155, fuel is fed from the fuel injector 8 to the burner combustion chamber 3 by the final amount of feed of fuel QF₀ calculated at step 154. Next, at step 156, the pump drive power required for making the target amount of feed of air QA calculated, at step 148 be discharged from the air pump 15 is supplied, to the air pump 15, then air is discharged from the air pump 15 by the target amount of feed of air QA. Next, at step 157, it is judged if the target O₂/C molar ratio calculated from the target amount of feed, of fuel QF and the target amount of feed of air QA becomes 0.5. When it is judged that the target O₂/C molar ratio does not become 0.5, the routine returns to step 152. As opposed to this, when at step 157 it is judged that the target O₂/C molar ratio becomes 0.5, it is judged that the secondary warm-up operation has ended. When it is judged that the secondary warm-up operation has ended, the routine proceeds to step 53 of FIG. 11 where normal operation is performed.

Next, the normal operational control performed at step 53 of FIG. 11 will be explained referring to FIG. 18 and FIG. 19. If referring to FIG. 18, first, at step 160 to step 164, the updating control of the learning value KG is performed. That is, at step 160, it is judged if the O₂/C molar ratio increase flag is set. When the O₂/C molar ratio increase flag is set, the routine proceeds to step 161 where the O₂/C molar ratio increase flag is reset, and next, the routine proceeds to step 164. As opposed to this, when at step 160 it is judged that the O₂/C molar ratio increase flag is not set, the routine proceeds to step 162.

At step 162, it is judged if the elapsed time Σt, that is, secondary warm-up operation time Σt, is shorter than the time ΔtX shown in FIG. 9 and FIG. 10. When the secondary warm-up operation time Σt is not shorter than the time ΔtX shown in FIG. 9 and FIG. 10, the routine jumps to step 164. As opposed to this, when the secondary warm-up operation time Σt is shorter than the time ΔtX shown in FIG. 9 and FIG. 10, the routine proceeds to step 163 where a new learning value KG (=KG·C2·ΔtX/Σt) is calculated. Next, at step 164, Σt and ΣΔTC/t are cleared. Next, the routine proceeds to step 165.

In this regard, in the embodiment of the present invention, as the operating mode at the time of normal operation, two operating modes, that is, the heat and hydrogen generating operating mode and the heat generating operating mode, can be selected. The heat and hydrogen generating operating mode is the operating mode for performing a partial oxidation reforming reaction by the O₂/C molar ratio=0.5. In this heat and hydrogen generating operating mode, heat and hydrogen are generated. On the other hand, the heat generating operating mode is an operating mode, for example, for performing a complete oxidation reaction by the O₂/C molar ratio=2.6. In this heat generating operating mode, hydrogen is not generated. Only heat is generated. These heat and hydrogen generating operating mode and heat generating operating mode are selectively used in accordance with need. Further, in this embodiment of the present invention, at the time of the heat and hydrogen generating operating mode, the action for updating the learning value KG is performed.

That is, at step 165, it is judged if the operating mode is the heat and hydrogen generating operating mode. When at step 165 it is judged that the operating mode is the heat and hydrogen generating operating mode, the routine proceeds to step 166 where the target amount of feed of fuel QF calculated at step 153 is multiplied with the learning value KG and thereby the final amount of feed of fuel QF₀ (=KG·QF) is calculated. Next, at step 167, fuel is fed from the fuel injector 8 to the burner combustion chamber 3 by the final amount of feed of fuel QF₀ calculated at step 166. Next, at step 168, the pump drive power required for making the target amount of feed of air QA calculated at step 148 be discharged from the air pump 15 is supplied to the air pump 15, then air is discharged from the air pump 15 by the target amount of feed of air QA. At this time, a partial oxidation reforming reaction is performed by the target O₂/C molar ratio=0.5 and heat and hydrogen are generated.

Next, at step 169, it is judged if the heat and hydrogen generating operating mode has continued for a predetermined t2 time, for example, 5 seconds. When the heat and hydrogen generating operating mode has not continued for a predetermined t2 time, the routine jumps to step 175 of FIG. 19. As opposed to this, when the heat and hydrogen generating operating mode has continued for a predetermined t2 time, the routine proceeds to step 170 where the temperature TC of the downstream side end face of the reformer catalyst 4 is read. Next, at step 171 of FIG. 19, it is judged if the temperature TC of the downstream side end face of the reformer catalyst 4 is higher than the value of the sum of the air temperature TA detected by the temperature sensor 24 and 805° C. (TA+805° C.) plus a small constant value α ((TA+805° C.)+α). When the temperature TC of the downstream side end face of the reformer catalyst 4 is higher than (TA+805° C.)+α, the routine proceeds to step 172 where the new learning value KG (=KG+C3·(TC−(TA+805° C.+α))) is calculated.

At this time, the learning value KG is increased in proportion to the difference between the temperature TC of the downstream side end face of the reformer catalyst 4 and (TA+805° C.)+α. That is, at this time, the amount of feed of fuel fed from the fuel injector 8 is increased and the actual O₂/C molar ratio is made to approach the target O₂/C molar ratio. Next, the routine proceeds to step 175. On the other hand, when at step 171 it is judged that the temperature TC of the downstream side end face of the reformer catalyst 4 is not higher than (TA+805° C.)+α, the routine proceeds to step 17 3 where it is judged if the temperature TC of the downstream side end face of the reformer catalyst 4 is lower than (TA805° C.). When the temperature TC of the downstream side end face of the reformer catalyst 4 is lower than even (TA+805° C.), the routine proceeds to step 174 where the new learning value KG (=KG−C3·((TA+805° C.)−TC))) is calculated.

At this time, the learning value KG is decreased in proportion to the difference between the temperature TC of the downstream side end face of the reformer catalyst 4 and (TA+805° C.). That is, at this time, the amount of feed of fuel fed from, the fuel injector 8 is decreased and the actual O₂/C molar ratio is made to approach the target O₂/C molar ratio. Next, the routine proceeds to step 175. On the other hand, when at step 173 it is judged that the temperature TC of the downstream side end face of the reformer catalyst 4 is not lower than (TA+805° C.), that is, when the temperature TC of the downstream side end face of the reformer catalyst 4 is between (TA+805° C.) and (TA+805° C.)+α, the routine proceeds to step 175. At this time, the learning value KG is not updated.

On the other hand, when at step 165 it is judged that the operating mode is not the heat and hydrogen generating operating mode, that is, when it is judged that it is the heat generating operating mode, the routine proceeds to step 176 where the O₂/C molar ratio is, for example, set to 2.6. Next, at step 177, the target amount of feed of air QA is calculated from the target amount of feed of fuel QF and target O₂/C molar ratio calculated at step 153. Next, at step 178, fuel is fed from the fuel injector 8 to the burner combustion chamber 3 by the target amount of feed of fuel QF calculated at step 153. Next, at step 179, the pump drive power required for making the target amount of feed of air QA calculated at step 177 be discharged from the air pump 15 is supplied to the air pump 15, then air is discharged from the air pump 15 by the target amount of feed of air QA. At this time, a complete oxidation reaction is performed, by an O₂/C molar ratio=2.6 and only heat is generated. Next, the routine proceeds to step 175.

At step 17 5, it is judged if an instruction for stopping operation of the heat and hydrogen generation device 1 is issued. The instruction for stopping operation of the heat and hydrogen generation device 1 is issued at the instruction generating part 39 shown in FIG. 1. When no instruction, for stopping operation of the heat and hydrogen generation device 1 is issued, the routine returns to step 165. As opposed to this, when at step 175 it is judged that an instruction for stopping operation of the heat and hydrogen generation device 1 is issued, the routine proceeds to step 180 where the feed of fuel from the fuel injector 8 is stopped. Next, at step 181, air is fed from the air pump 15 so as to burn off the remaining fuel. Next, at step 182, it is judged, if a fixed time has elapsed. When it is judged that the fixed time has not elapsed, the routine returns to step 181.

As opposed to this, when at step 182 it is judged that the fixed time has elapsed, the routine proceeds to step 183 where operation of the air pump 15 is stopped and the feed of air to the inside of the burner combustion chamber 3 is stopped. Next, at step 184, the low temperature air valve 17 is closed, while at step 185, the high temperature air valve 16 is opened. Next, while the operation of the heat and hydrogen generation device 1 is made to stop, the low temperature air valve 17 continues closed and the high temperature air valve 16 continues opened.

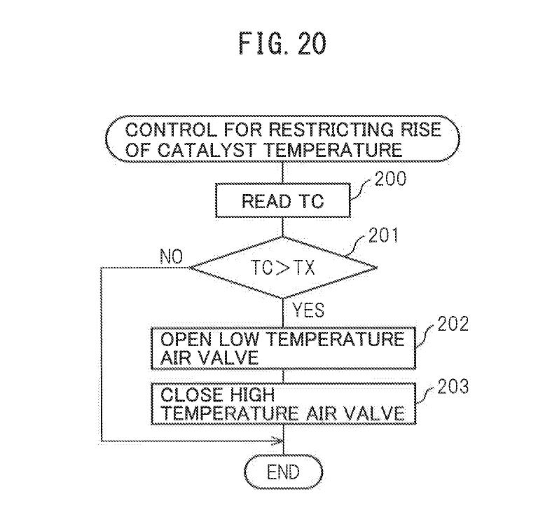

Next, referring to FIG. 20, the routine for control for restricting the rise of the catalyst temperature will be explained. This routine is executed by interruption every fixed time. Referring to FIG. 20, first, at step 200, the temperature TC of the downstream, side end face of the reformer catalyst 4 detected by the temperature sensor 23 is read. Next, at step 201, it is judged if the temperature TC of the downstream side end face of the reformer catalyst 4 exceeds the allowable catalyst temperature TX. When it is judged that the temperature TC of the downstream side end face of the reformer catalyst 4 does not exceed the allowable catalyst temperature TX, the processing cycle is ended.

As opposed to this, when at step 201 it is judged that the temperature TC of the downstream side end face of the reformer catalyst 4 exceeds the allowable catalyst temperature TX, the routine proceeds to step 202 where the low temperature air valve 17 is opened. Next, at step 203, the high temperature air valve 16 is closed. Next, the processing cycle is ended. That is, when, during operation of the heat and hydrogen generation device 1, the temperature TC of the downstream side end face of the reformer catalyst 4 exceeds the allowable catalyst temperature TX, the air flow route for feeding air into the burner combustion chamber 3 is switched, from the high temperature air flow route for feeding a high temperature air to the low temperature air flow route for feeding a low temperature air, and the temperature of the air for burner combustion fed into the burner combustion chamber 3 is made to drop.

Now then, as explained above, sit the time of the primary warm-up operation, the fuel, fed from the burner 7 into the burner combustion chamber 3 and the air fed from the burner 7 into the burner combustion chamber 3 are made to burn at the burner under a lean air-fuel ratio. Next, if the operation of the heat and hydrogen generation device 1 is shifted from the primary warm-up operation to the secondary warm-up operation, the feed of high temperature air from the high temperature air flow route 13 to the burner combustion chamber 3 is immediately stopped and a low temperature air is fed from the low temperature air flow route 14 into the burner combustion chamber 3. In other words, if the operation of the heat and hydrogen generation device 1 is shifted from the primary warm-up operation to the secondary warm-up operation, the air flow route feeding air from the burner 7 into the burner combustion chamber 3 is immediately switched from the high temperature air flow route for feeding a high temperature air to the low temperature air flow route for feeding a low temperature air.

That is, when the operation of the heat and hydrogen generation device 1 is shifted from the primary warm-up operation to the secondary warm-up operation, if continuing to feed a high temperature air from the high temperature air flow route 13 into the burner combustion chamber 3, it is predicted that sooner or later the temperature of the reformer catalyst 4 will exceed the allowable catalyst temperature TX. Therefore, in the embodiment of the present invention, as shown in FIG. 7, when the operation of the heat and hydrogen generation device 1 is shifted, from the primary warm-up operation to the secondary warm-up operation, that is, when it is predicted that the temperature of the reformer catalyst 4 will exceed the allowable catalyst temperature TX, the air flow route feeding the air into the burner combustion chamber 3 is switched from the high temperature air flow route for feeding a high temperature air to the low temperature air flow route for feeding a low temperature air, and the temperature of the air for burner combustion fed into the burner combustion chamber 3 is made to drop.

On the other hand, in the embodiment of the present invention, as is performed in the routine for control for restricting the rise of the catalyst temperature shown in FIG. 20, when the temperature TC of the downstream side end face of the reformer catalyst 4 actually exceeds the allowable catalyst temperature TX during operation of the heat and hydrogen generation device 1, the air flow route feeding the air from the burner 7 into the burner combustion chamber 3 is switched from the high temperature air flow route for feeding a high temperature air to the low temperature air flow route for feeding a low temperature air, and the temperature of the air fed from the burner 7 into the burner combustion chamber 3 is made to drop. Therefore, the temperature of the reformer catalyst 4 is kept from excessively rising and therefore heat degradation of the reformer catalyst 4 is suppressed.

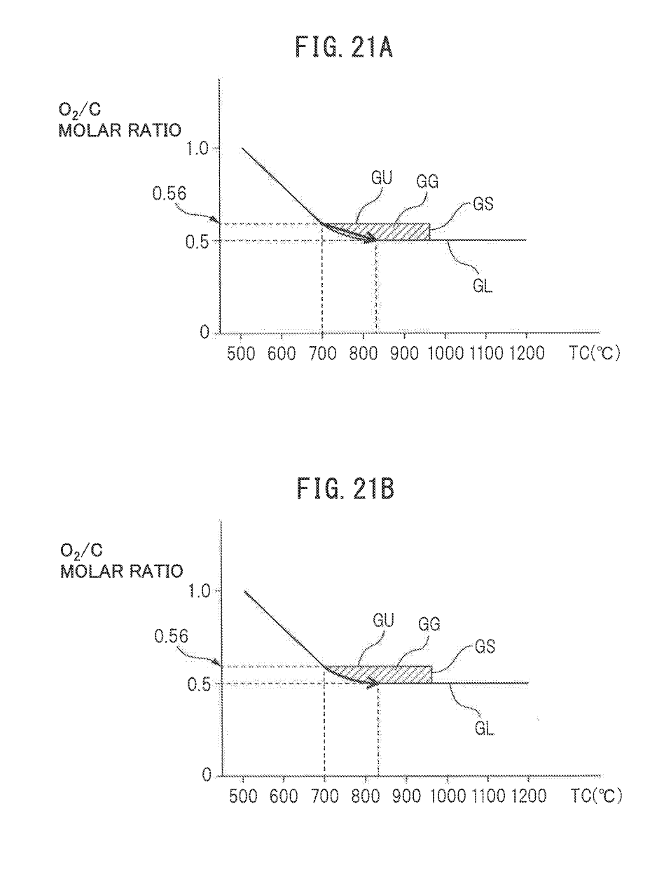

FIG. 21A and FIG. 21B show a modification of the secondary warm-up control up to the normal operation shown in FIG. 8B. As explained above, in the example shown in FIG. 8B, as shown by the arrow, if the temperature of the downstream side end face of the reformer catalyst 4 becomes 700° C., to promote the secondary warm-up of the reformer catalyst 4, a partial oxidation reforming reaction is started by an O₂/C molar ratio=0.56. Next, If the temperature TC of the downstream side end face of the reformer catalyst 4 becomes 830° C., the O₂/C molar ratio is made to decrease until an O₂/C molar ratio=0.5.

As opposed to this, in the modification shown in FIG. 21A, as shown by the arrow, if the temperature of the downstream, side end face of the reformer catalyst 4 becomes 700° C., a partial oxidation reforming reaction is started by an O₂/C molar ratio=0.56. Next, the O₂/C molar ratio is made to gradually decrease until the temperature TC of the downstream side end face of the reformer catalyst 4 becomes 830° C. and the O₂/C molar ratio becomes 0.5. On the other hand, in the modification shown in FIG. 21B, as shown by the arrow, if the temperature of the downstream side end face of the reformer catalyst 4 becomes 700° C., a partial oxidation reforming reaction is started by an O₂/C molar ratio=0.56. Next, the O₂/C molar ratio is made to decrease along the boundary GL of the O₂/C molar ratio with respect to coking until the temperature TC of the downstream side end face of the reformer catalyst 4 becomes 830° C. and the O₂/C molar ratio=0.5.

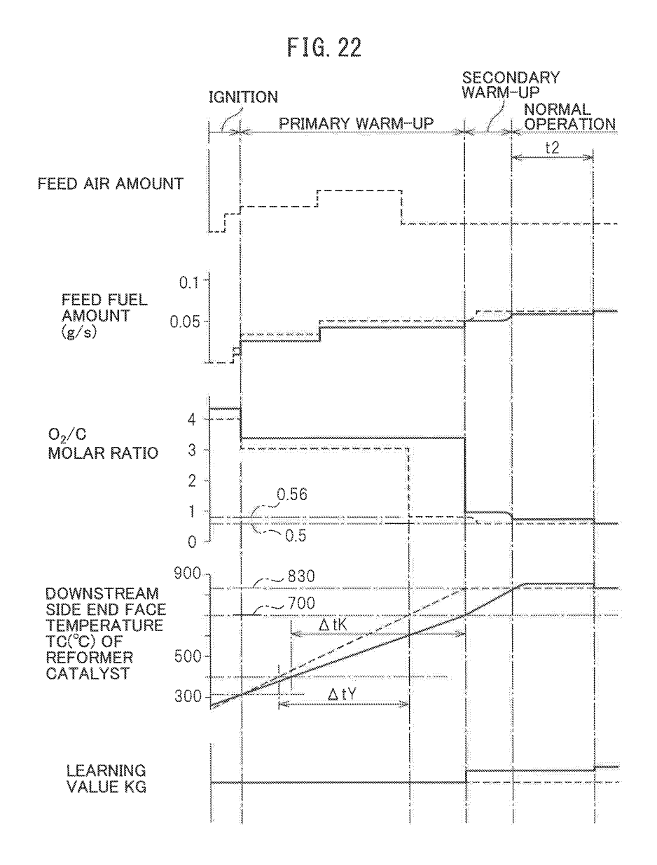

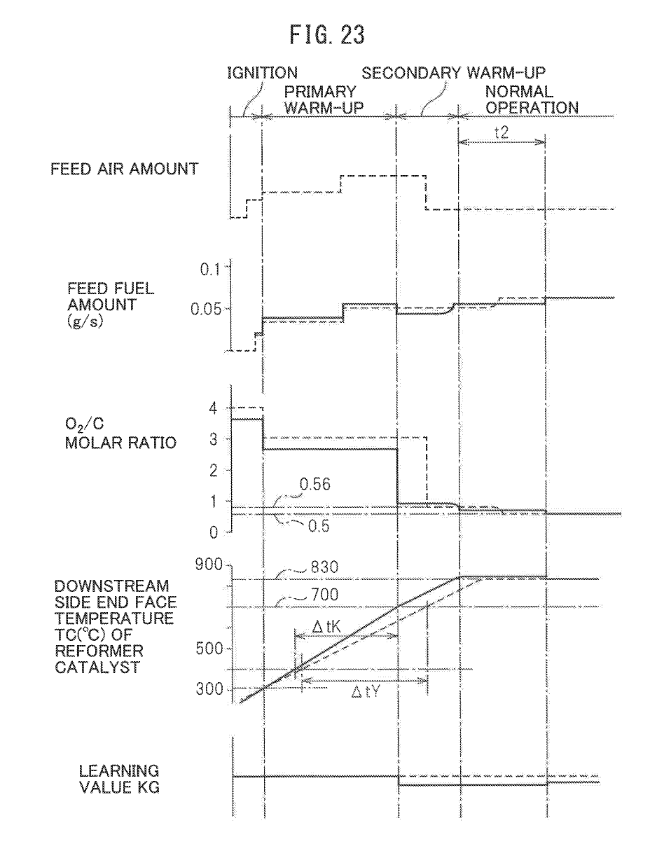

Next, referring to FIG. 22 and FIG. 23, a second embodiment according to the present invention will be explained. As explained above, at the time of the primary warm-up operation, a complete oxidation reaction is performed under a large ratio of an O₂/C molar ratio of for example 2.6, that is, a state of oxygen excess. Therefore, at the time of the primary warm-up operation, even if the amount of feed of air changes somewhat, the amount of heat generated due to combustion does not change much at all. Therefore, at the time of the primary warm-up operation, even if the amount of feed of air changes, the rate of temperature rise of the reformer catalyst 4, amount of temperature rise of the reformer catalyst 4, or time required for temperature rise of the reformer catalyst 4 at the time of the primary warm-up operation does not change much at ail. As opposed to this, at the time of the primary warm-up operation, if the amount of feed of fuel changes, the amount of heat generation due to combustion changes along with this. Therefore, at the time of the primary warm-up operation, if the amount of feed of fuel changes, the rate of temperature rise of the reformer catalyst 4, amount of temperature rise of the reformer catalyst 4, or time required for temperature rise of the reformer catalyst 4 at the time of the primary warm-up operation will change.

Therefore, at the time of the primary warm-up operation, it is difficult to accurately find the actual O₂/C molar ratio from the rate of temperature rise of the reformer catalyst 4, amount of temperature rise of the reformer catalyst 4, or time required for temperature rise of the reformer catalyst 4 at the time of the primary warm-up operation. However, in actuality, the case where the actual amount of feed of air deviates from, the target amount of feed of air occurs less often than the case where the actual amount of feed of fuel deviates from the target amount of feed of fuel. Therefore, while it cannot be said to be perfect, it is possible to estimate the actual O₂/C molar ratio from, the rate of temperature rise of the reformer catalyst 4, amount of temperature rise of the reformer catalyst 4, or time required for temperature rise of the reformer catalyst 4 at the time of the primary warm-up. Therefore, in the second embodiment according to the present invention, the actual O₂/C molar ratio is estimated from the rate of temperature rise of the reformer catalyst 4, amount of temperature rise of the reformer catalyst 4, or time required for temperature rise of the reformer catalyst 4 at the time of the primary warm-up.

In this regard, at the time of the primary warm-up operation, if the amount of feed of fuel increases, the rate of temperature rise of the reformer catalyst 4 increases and the time required for temperature rise of the reformer catalyst 4 becomes shorter. On the other hand, if the amount of feed of fuel decreases, the rate of temperature rise of the reformer catalyst 4 decreases and the time required for temperature rise of the reformer catalyst 4 becomes longer. Therefore, in this second embodiment, the amount of feed of fuel is controlled based on the time required for temperature rise of the reformer catalyst 4.

Now then, FIG. 22 and FIG. 23 show the change of the amount of feed of air from, the burner 7, the change of the amount of feed of fuel from the burner 7, the change of the O₂/C molar ratio of the air and fuel which are made to react, the change of the temperature TC of the downstream side end face of the reformer catalyst 4, and the change of the learning value KG for part of the ignition, primary warm-up operation, secondary warm-up operation, and normal operation in FIG. 7. Note, in FIG. 22 and FIG. 23, the broken lines show the cases where the actual O₂/C molar ratio, the actual amount of fuel injection, and the actual amount of feed of air respectively match the target O₂/C molar ratio, target amount of fuel injection, and target amount of feed of air, that is, the case shown in FIG. 7.

The solid line in FIG. 22, as one example, shows the heat and hydrogen generation, control when the actual amount of feed of fuel fed from the fuel injector 8 decreases from the target amount of feed of fuel for some reason or another. Note, below, the explanation will be given assuming that the amount of feed of air is maintained at the target amount of feed of air. Now, if the actual amount of feed of fuel decreases from, the target amount of feed of fuel, at the time of the primary warm-up operation of FIG. 22, as shown by the solid line, the actual O₂/C molar ratio becomes larger than the target O₂/C molar ratio. If the actual O₂/C molar ratio becomes larger than, the target O₂/C molar ratio, as will be understood from FIG. 3, the reaction equilibrium temperature TB when the reformer catalyst 4 becomes an equilibrium, state becomes much higher,

In this case, if allowing the state where the actual O₂/C molar ratio is larger than the target O₂/C molar ratio to stand, when the temperature TC of the downstream side end face of the reformer catalyst 4 reaches the reaction equilibrium temperature TB, the temperature of the reformer catalyst 4 will rise to the allowable catalyst temperature TX enabling heat degradation of the reformer catalyst 4 to be avoided and as a result, there is the danger of heat degradation of the reformer catalyst 4. Therefore, it is not possible to allow the state where the actual O₂/C molar ratio is higher than the target O₂/C molar ratio to stand. Therefore, in the embodiment shown in FIG. 22, the actual O₂/C molar ratio at the time of the primary warm-up operation is estimated from the rate of temperature rise of the reformer catalyst 4, amount of temperature rise of the reformer catalyst 4, or time required for temperature rise of the reformer catalyst 4 when performing the primary warm-up operation. When the estimated actual O₂/C molar ratio deviates from the target O₂/C molar ratio, the ratio of feed between the amount of feed of air for burner combustion and the amount of feed of fuel for burner combustion is corrected in a direction making the estimated actual O₂/C molar ratio approach the target O₂/C molar ratio. Note, in this case, in the example shown in FIG. 22, the amount of feed of fuel for burner combustion is corrected in a direction making the estimated actual O₂/C molar ratio approach the target O₂/C molar ratio.

Specifically speaking, in the example shown in FIG. 22, at the time of the primary warm-up operation, the time required for the temperature TC of the downstream side end face of the reformer catalyst 4 to rise from, for example, 400° C. to 700° C., that is, the time required for temperature rise Σt, is calculated. Note, in FIG. 22, the time required for temperature rise Σt when the actual amount of feed of fuel is maintained at the target amount of feed of fuel is shown by ΔtY, while the time required for temperature rise Σt when the actual amount of feed of fuel is decreased from the target amount of feed of fuel is shown by ΔtK. As will be understood from FIG. 22, the more the actual amount of feed of fuel fails compared with the target amount of feed of fuel, that is, the larger the actual O₂/C molar ratio becomes compared with the target O₂/C molar ratio, the longer the time required for temperature rise Σt becomes longer.

Therefore, in the example shown in FIG. 22, if the time required, for the temperature rise Σt, as shown by ΔtK, becomes longer than the time required for the temperature rise ΔtY, when the secondary warm-up operation is started, the learning value KG is immediately increased and the actual amount of feed of fuel QF₀ (=learning value KG·target amount of feed, of fuel QF) immediately increases with respect to the target amount of feed of fuel QF so that the reformer catalyst 4 does not degrade due to heat. Note, in this case as well, in the same way as the first embodiment according to the present invention, the learning value KG is determined so that the actual O₂/C molar ratio when the normal operation is started becomes somewhat higher than 0.5. Further, in this case, in the example shown in FIG. 22, the learning value KG is calculated from the time required for the temperature rise ΔtK and the time required for the temperature rise ΔtY.

That is, the longer the time required for temperature rise ΔtK compared with the time required for temperature rise ΔtY, that is, the slower the rate of temperature rise of the reformer catalyst 4 at the time of the primary warm-up operation, the more necessary It is to increase the amount of feed of fuel and lower the actual O₂/C molar ratio at the time of the secondary warm-up operation. Therefore, in the example shown in FIG. 22, the learning value KG is multiplied with a constant C4·(time required for temperature rise ΔtK/time required for temperature rise ΔtY) to find a new learning value KG. Of course, in this case, in the same way as the first embodiment according to the present invention, it is possible to find the optimum learning value KG corresponding to the length of the time required for temperature rise ΔtK in advance by experiments, store the optimum learning value KG found by experiments in the ROM 32, and use as the learning value KG the learning value stored in advance corresponding to the length of the time required for temperature rise ΔtK.

On the other hand, the solid line in FIG. 23, as one example, shows the heat and hydrogen generation control when the actual amount of feed of fuel fed from the fuel injector 8 increases from the target amount of feed of fuel for some reason or another. Note, below, the explanation will be given assuming that the amount, of feed of air is maintained at the target amount of feed of air. Now, if the actual amount of feed, of fuel increases from the target amount of feed of fuel, as shown by the solid line at the time of the primary warm-up of FIG. 23, the actual O₂/C molar ratio becomes smaller than the target O₂/C molar ratio. If the actual O₂/C molar ratio becomes smaller than the target O₂/C molar ratio, as will be understood from FIG. 3, the reaction equilibrium temperature TB when the reformer catalyst 4 becomes an equilibrium state becomes lower.

In this case, if allowing the state where the actual O₂/C molar ratio is lower than the target O₂/C molar ratio to stand in this way, when the temperature TC of the downstream, side end face of the reformer catalyst 4 reaches the reaction equilibrium temperature TB, the actual O₂/C molar ratio would become lower than 0.5 and as a result there is the danger of coking occurring. Therefore, the state where the actual O₂/C molar ratio is lower than the target O₂/C molar ratio cannot be allowed to stand. Accordingly, in the embodiment shown in FIG. 23, the actual O₂/C molar ratio at the time of the primary warm-up operation is estimated from the rate of temperature rise of the reformer catalyst 4, amount of temperature rise of the reformer catalyst 4, or time required, for temperature rise of the reformer catalyst 4 when performing the primary warm-up operation, and the ratio of feed between the amount of feed of air for burner combustion and the amount of feed of fuel for burner combustion is corrected in a direction making the estimated, actual O₂/C molar ratio approach the target O₂/C molar ratio when the estimated actual O₂/C molar ratio deviates from the target O₂/C molar ratio. Note, in this case, in the example shown in FIG. 23, the amount of feed of fuel for burner combustion is corrected in a direction making the estimated actual O₂/C molar ratio approach the target O₂/C molar ratio.

Specifically speaking, in the example shown in FIG. 23 as well, at the time of the primary warm-up operation, the time required for the temperature TC of the downstream side end face of the reformer catalyst 4 to rise from, for example, 400° C. to 700° C., that is, the time required for temperature rise Σt, is calculated. Note, in FIG. 23, the time required for temperature rise Σt when the actual amount of feed of fuel is maintained at the target amount of feed of fuel is shown by ΔtY, while the time required for temperature rise Σt when the actual amount of feed of fuel is increased from the target amount of feed of fuel is shown by ΔtK. As will be understood from FIG. 23, the more the actual amount of feed of fuel increases compared with the target amount of feed of fuel, that is, the smaller the actual O₂/C molar ratio becomes compared with the target O₂/C molar ratio, the shorter the time required for the temperature rise Σt.

Therefore, in the example shown in FIG. 23, if the time required for temperature rise Σt becomes shorter as shown by ΔtK compared with the time required for the temperature rise ΔtY, when the secondary warm-up is started, the learning value KG immediately falls and the actual amount of feed of fuel QF₀ (=learning value KG·target amount of feed of fuel QF) immediately decreases from the target amount of feed of fuel QF so that the reformer catalyst 4 does not coke. Note, in this case as well, in the same way as the first embodiment according to the present invention, the learning value KG is determined so that the actual O₂/C molar ratio when the normal operation is started becomes somewhat higher than 0.5. Further, in this case, in the example shown in FIG. 23, the learning value KG is calculated from the time required for temperature rise ΔtK and the time required for temperature rise ΔtY.

That is, the shorter the time required for temperature rise ΔtK compared with the time required for temperature rise ΔtY, that is, the faster the rate of temperature rise of the reformer catalyst 4 at the time of the primary warm-up operation, the more it is necessary to decrease the amount of feed, of fuel and raise the actual O₂/C molar ratio at the time of the secondary warm-up operation. Therefore, in the example shown in FIG. 23, the learning value KG is multiplied with the constant C5·(time required for temperature rise ΔtK/time required for temperature rise ΔtY) to find a new learning value KG. Of course, in this case, in the same way as the first embodiment according to the present, invention, the optimum learning value KG corresponding to the length of the time required, for temperature rise ΔtK is found in advance by experiments, the optimum learning value KG found by experiments is stored in the ROM 32, and the learning value stored in advance corresponding to the length of the time required for the temperature rise ΔtK can be used as the learning value KG.

On the other hand, in this second embodiment as well, in the same way as the first embodiment, the learning value KG is corrected every time a predetermined fixed time t2 elapses after shifting to the normal operation. That is, when at this time the temperature TC of the downstream side end face of the reformer catalyst 4 is not the reaction equilibrium temperature TB, the actual O₂/C molar ratio deviates from the target O₂/C molar ratio=0.5. At this time, if using the relationship shown in FIG. 3, the amount of deviation of the actual O₂/C molar ratio from the target O₂/C molar ratio can be learned from the temperature difference between the temperature TC of the downstream side end face of the reformer catalyst 4 and the reaction equilibrium, temperature (TA+805° C.). If the amount of deviation of the actual O₂/C molar ratio with respect to the target O₂/C molar ratio can be learned, the amount of correction, of the learning value KG required for making the actual O₂/C molar ratio the target O₂/C molar ratio can be learned. The learning value KG is corrected in this way.

Giving one example, in the same way as the first embodiment, when a predetermined fixed time t2 elapses after shifting to the normal operation, if the temperature TC of the downstream, side end face of the reformer catalyst 4 is between (TA+805° C.) and (TA+805° C.)+α (α is a small constant value), the learning value KG is not updated. As opposed to this, if the temperature TC of the downstream side end face of the reformer catalyst 4 becomes higher than (TA+805° C.)+α, C3 (constant)·(TC−(TA+805° C.+α)) is added to the learning value KG. Due to this, the amount of fuel injection from the fuel injector 8 is increased. On the other hand, if the temperature TC of the downstream side end face of the reformer catalyst 4 becomes lower than (TA+805° C.), C3 (constant)·((TA+805° C.)−TC) is subtracted from the learning value KG. Due to this, the amount of fuel injection from the fuel injector 8 is decreased. Note, in this second embodiment as well, at the normal operation, such action for updating the learning value KG is performed, every fixed time t2.

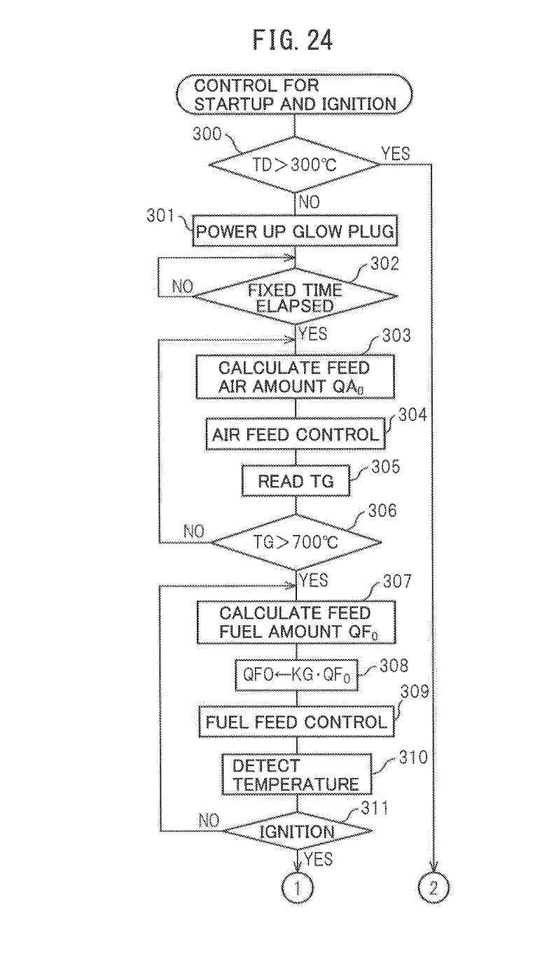

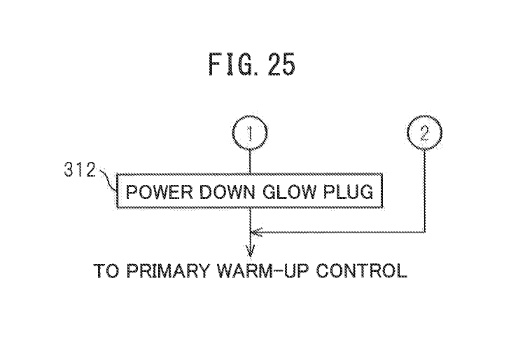

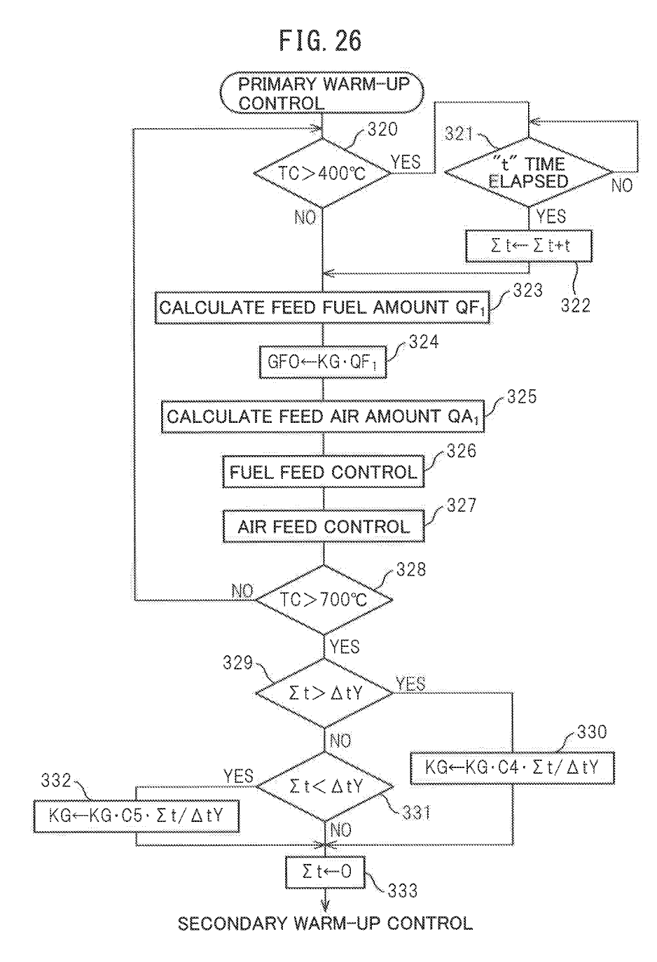

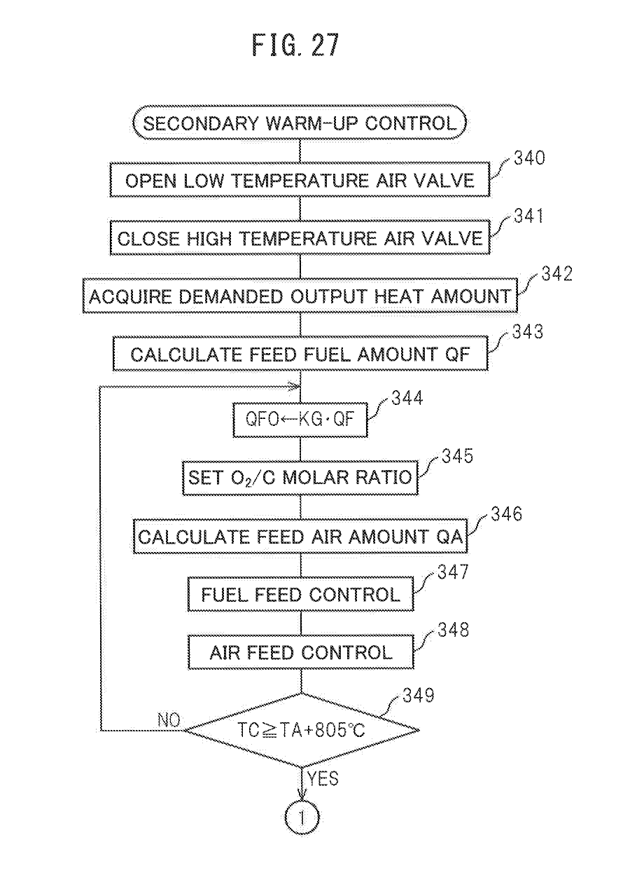

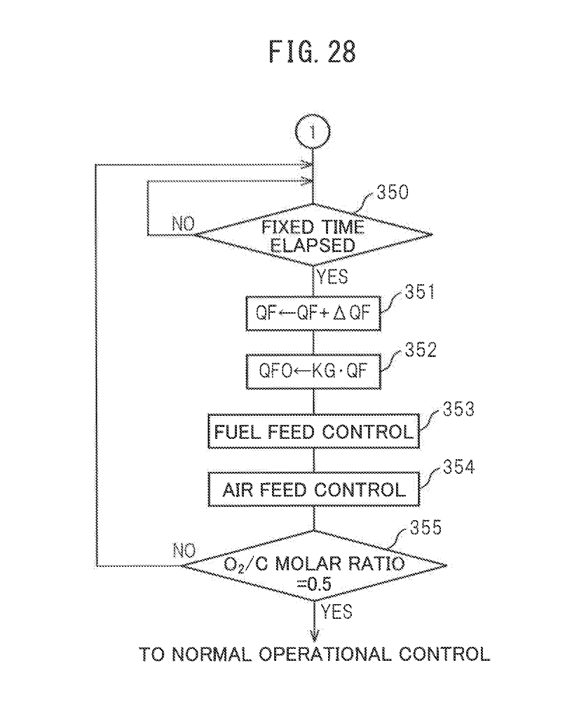

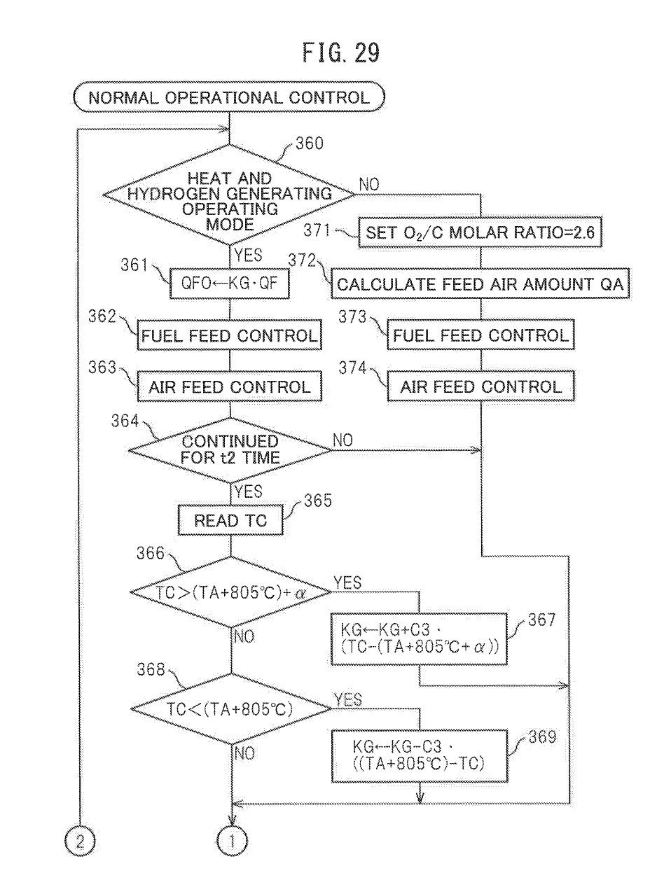

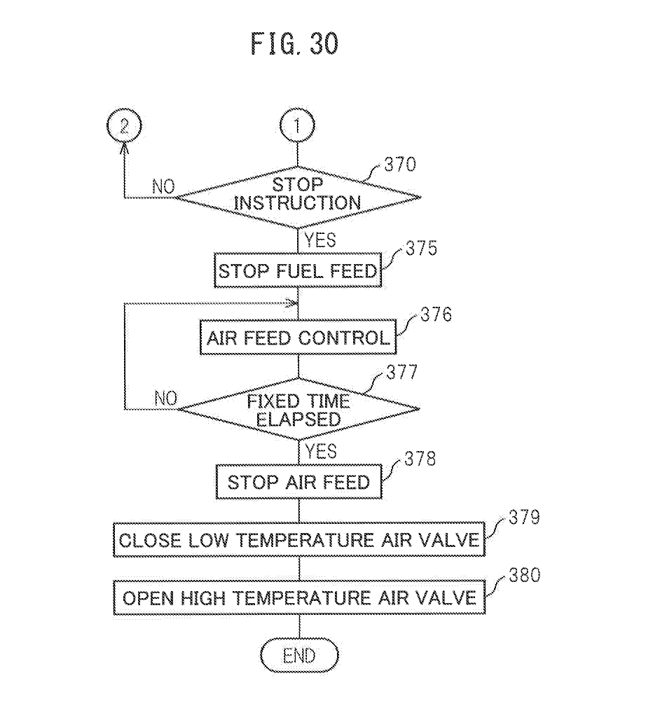

Next, referring to FIG. 11 and FIG. 24 to FIG. 30, the heat and hydrogen generation control routine for performing the second embodiment, according to the present invention shown in FIG. 22 and FIG. 23 will be explained. This heat and hydrogen generation control routine is executed, when the instruction generating part 39 shown in FIG. 1 issues an instruction for starting the heat and hydrogen generation control. Note, in this second, embodiment as well, the heat and hydrogen generation control routine shown in FIG. 11 is used. The startup and Ignition control routine of the heat and hydrogen generation device 1 executed at step 50 of FIG. 11 is as shown in FIG. 24 and FIG. 25, the primary warm-up control routine of the heat and hydrogen generation device 1 executed at step 51 of FIG. 11 is as shown in FIG. 26, the secondary warm-up control routine of the heat and hydrogen generation device 1 executed, at step 52 of FIG. 11 is as shown in FIG. 27 and FIG. 28, and the normal operational control routine of the heat and hydrogen generation device 1 executed at step 53 of FIG. 11 is as shown in FIG. 29 and FIG. 30.

Now, first, referring to the startup and ignition control routine shown in FIG. 24 and FIG. 25, step 300 to step 312 in this startup and ignition control routine are completely the same as step 100 to step 112 at the startup and ignition control routine shown in FIG. 12 and FIG. 13. Therefore, the explanation of the startup and ignition control routine shown in FIG. 24 and FIG. 25 will be omitted. The explanation will be given from the primary warm-up control performed at step 51 of FIG. 11.

Referring to FIG. 2 6 showing this primary warm-up control performed at step 51 of FIG. 11, first, at step 320, it is judged, if the temperature TC of the downstream side end face of the reformer catalyst 4 exceeds 400° C. based on the output signal of the temperature sensor 23. When it is judged that the temperature TC of the downstream side end face of the reformer catalyst 4 does not exceed 400° C., the routine proceeds to step 323. As opposed to this, when it is judged that the temperature TC of the downstream side end face of the reformer catalyst 4 exceeds 400° C., the routine proceeds to step 32.1 where it is judged if the fixed time “t” has elapsed. If the fixed time “t” has elapsed, the routine proceeds to step 322 where this fixed time t is added to Σt. Therefore, this Σt expresses the elapsed time from when the temperature TC of the downstream side end face of the reformer catalyst 4 exceeds 400° C. Next, the routine proceeds to step 323.

At step 323, the target amount of feed of fuel QF₁ at the time of the primary warm-up operation is calculated. This target amount of feed of fuel QF₁ is stored in advance in the ROM 32. Next, at step 324, this target amount of feed of fuel QF₁ is multiplied with, the learning value KG and thereby the final amount of feed of fuel QF₀ (=KG·QF₁) is calculated. Next, at step 325, the target amount of feed of air QA₁ is calculated from the target amount of feed of fuel QF₁ and target O₂/C molar ratio. Note, as shown in FIG. 7 and FIG. 22, at this time, the target O₂/C molar ratio is made 3.0. Next, at step 326, fuel is injected from the fuel injector 8 into the burner combustion chamber 3 by the final amount of feed of fuel QF₀ calculated at step 324. Next, at step 327, the pump drive power required for making the target amount of feed of air QA₁ calculated at step 325 be discharged from the air pump 15 is supplied to the air pump 15 and air is discharged from the air pump 15 by the target amount of feed of air QA₁.

At this time, that is, at the time of the primary warm-up operation, the air discharged from the air pump 15 is fed through the high temperature air flow route 13 into the burner combustion chamber 3. Note, in the embodiment of the present invention, when this primary warm-up operation is being performed, as shown in FIG. 7 and FIG. 22, the amount of feed of air and the amount of feed of fuel are increased in stages. Next, at step 328, based on the output signal of the temperature sensor 23, it is judged if the temperature TC of the downstream side end face of the reformer catalyst 4 exceeds 700° C. When it is judged that the temperature TC of the downstream side end face of the reformer catalyst 4 does not exceed 700° C., the routine returns to step 320 where the primary warm-up operation is continued. As opposed to this, when it is judged if the temperature TC of the downstream side end face of the reformer catalyst 4 exceeds 700° C., the routine proceeds to step 329.

At step 329, it is judged if the elapsed time Σt from when the temperature TC of the downstream side end face of the reformer catalyst 4 has exceeded the 400° C., that is, the time required for temperature rise ΔtK, is longer than the time required for temperature rise ΔtY. When the elapsed, time Σt, that is, the time required for temperature rise ΔtK, is longer than the time required for temperature rise ΔtY, the routine proceeds to step 330 where a new learning value KG (=constant C4·(Σt/ΔtY) is calculated. Next, the routine proceeds to step 333. On the other hand, when at step 329 it is judged that the elapsed, time Σt, that is, the time required for temperature rise ΔtK, is not longer than the time required for temperature rise ΔtY, the routine proceeds to step 331 where it is judged if the elapsed time Σt, that is, the time required for temperature rise ΔtK, is shorter than the time required for temperature rise ΔtY. When the elapsed, time Σt, that is, the time required for temperature rise ΔtK, is shorter than the time required for temperature rise ΔtY, the routine proceeds to step 332 where a new learning value KG (=constant C5·(Σt/ΔtY) is calculated. Next, the routine proceeds to step 333. On the other hand, when at step 331 it is judged that the elapsed time Σt, that is, the time required for temperature rise ΔtK, it is not shorter than the time required, for temperature rise ΔtY, the routine proceeds to step 333. At step 333, Σt is cleared. Next, the routine proceeds to step 52 shown in FIG. 11 where secondary warm-up control, that is, a partial oxidation reforming reaction, is started.

Next, the secondary warm-up control performed at step 52 of FIG. 11 will be explained while referring to FIG. 27 and FIG. 28. If the secondary warm-up control, that is, a partial oxidation reforming reaction, is started, as shown, in FIG. 27, first, at step 340, the low temperature air valve 17 is opened, and then at step 341, the high temperature air valve 16 is closed. Therefore, at this time, air is fed through the low temperature air flow route 14 into the burner combustion chamber 3. Next, at step 342, the demanded value of the amount of output heat (kW) is obtained. For example, when the heat and hydrogen generation device 1 is used for warming up an exhaust purification catalyst of a vehicle, the demanded value of this amount of output heat is made the amount of heat required for making an exhaust purification catalyst rise to an activation temperature. Next, at step 343, the amount of feed of fuel QF required for generating the demanded amount of output heat of this amount of output heat (kW) is calculated. Next, the routine proceeds to step 344.

At step 344, the target amount of feed of fuel QF calculated at step 343 is multiplied with the learning value KG and thereby the final amount of feed of fuel QF₀ (=KG·QF) is calculated. Next, at step 345, the target O₂/C molar ratio at the time of the secondary warm-up operation is set. In the embodiment of the present invention, this target O₂/C molar ratio is made 0.56. Next, at step 346, the target amount of feed of air QA is calculated from the target amount of feed of fuel QF and the target O₂/C molar ratio. Next, at step 347, fuel is injected from the fuel injector 8 into the burner combustion chamber 3 by the final amount of feed of fuel QF₀ calculated at step 344. Next, at step 348, the pump drive power required for making the target amount of feed of air QA calculated at step 346 be discharged from the air pump) 15 is supplied to the air pump 15, then air is discharged from the air pump 15 by the target amount of feed of air QA.

At this time, a partial oxidation reforming reaction is performed and hydrogen is generated. Next, at step 349, it is judged if the temperature TC of the downstream side end face of the reformer catalyst 4 reaches the sum (TA+805° C.) of the air temperature TA detected at the temperature sensor 24 and 805° C. As explained above, this temperature (TA+805° C.) shows the reaction equilibrium temperature TB when a partial oxidation reforming reaction is performed by an O₂/C molar ratio=0.5 when the air temperature is TA° C. Therefore, at step 349, it is judged if the temperature TC of the downstream side end face of the reformer catalyst 4 reaches the reaction equilibrium temperature (TA+805° C.). When It is judged that the temperature TC of the downstream side end face of the reformer catalyst 4 does not reach the reaction equilibrium temperature (TA+805° C.), the routine returns to step 344.

As opposed to this, when at step 349 it is judged that the temperature TC of the downstream side end face of the reformer catalyst 4 reaches the reaction equilibrium temperature (TA+805° C.), the routine proceeds to step 350 of FIG. 28. At step 350 to step 355, in the state maintaining the amount of discharge of the air pump 15 constant, the amount of feed of fuel is gradually increased until the target O₂/C molar ratio becomes 0.5, and thus the target O₂/C molar ratio is gradually made to decrease. That is, at step 350, it is judged if a fixed time has elapsed. When the fixed time has elapsed, the routine proceeds to step 351. That is, the routine proceeds to step 351 every time the fixed time elapses. At step 351, the target amount, of feed of fuel QF is increased by exactly a small constant, value ΔQF. Next, at step 352, the target amount of feed of fuel QF calculated at step 351 is multiplied with the learning value KG and thereby the final amount of feed of fuel QF0 (=KG·QF) is calculated.

Next, at step 353, fuel is injected from the fuel injector 8 into the burner combustion chamber 3 by the final amount of feed of fuel QF0 calculated at step 352. Next, at step 354, the pump drive power required for making the target amount of feed of air QA calculated at step 346 be discharged from the air pump 15 is supplied to the air pump 15, then air is discharged from the air pump 15 by the target amount, of feed of air QA. Next, at step 355, it is judged if the target O₂/C molar ratio calculated from the target amount of feed of fuel QF and the target amount of feed of air QA becomes 0.5. When it is judged that the target O₂/C molar ratio does not become 0.5, the routine returns to step 350. As opposed to this, when at step 355 it is judged, that the target O₂/C molar ratio becomes 0.5, it is judged that the secondary warm-up operation has ended. When it is judged that the secondary warm-up operation has ended, the routine proceeds to step 53 of FIG. 11 where the normal operation is performed.

Next, the normal operational control performed at step 53 of FIG. 11 will be explained while referring to FIG. 29 and FIG. 30. Referring to FIG. 29, first, at step 360, it is judged if the operating mode is the heat and hydrogen generating operating mode. When at step 360 it is judged that the operating mode is the heat and hydrogen generating operating mode, the routine proceeds to step 361 where the target amount of feed of fuel QF calculated at step 351 is multiplied with the learning value KG and thereby the final amount of feed of fuel QF0 (=KG·QF) is calculated. Next, at step 362, fuel Is injected from the fuel injector 8 into the burner combustion chamber 3 by the final amount, of feed of fuel QF0 calculated at step 361. Next, at step 363, the pump drive power required for making the target amount of feed of air QA calculated at step 346 be discharged from the air pump 15 is supplied, to the air pump 15, then air is discharged from the air pump 15 by the target amount of feed of air QA. At this time, a partial oxidation reforming reaction is performed by the target O₂/C molar ratio=0.5 and heat and hydrogen are generated.

Next, at step 364, it is judged if the heat and hydrogen generating operating mode has continued for at predetermined t2 time. When the heat and hydrogen generating operating mode has not continued for the predetermined t2 time, the routine jumps to step 370 of FIG. 30. As opposed to this, when the heat and hydrogen generating operating mode has continued for the predetermined t2 time, the routine proceeds to step 365 where the temperature TC of the downstream side end face of the reformer catalyst 4 is read. Next, at step 366, it is judged if the temperature TC of the downstream side end face of the reformer catalyst 4 is higher than the sum (TA+805° C.) of the air temperature TA detected, by the temperature sensor 24 and 805° C. plus a small constant a ((TA+805° C.)+α). When the temperature TC of the downstream side end face of the reformer catalyst 4 is higher than (TA+805° C.)+α, the routine proceeds to step 367 where a new learning value KG (=KG+C3·(TC−(TA+805° C.+α)))) is calculated.

At this time, the learning value KG increases proportionally to the difference of the temperature TC of the downstream, side end face of the reformer catalyst 4 and (TA+805° C.)+α. That is, at this time, the amount of feed of fuel fed from the fuel injector 8 is increased and the actual O₂/C molar ratio is made to approach the target. O₂/C molar ratio. Next, the routine proceeds to step 370. On the other hand, when at step 366 it is judged that the temperature TC of the downstream side end face of the reformer catalyst 4 is not higher than (TA+805° C.)+α, the routine proceeds to step 368 where it is judged if the temperature TC of the downstream, side end face of the reformer catalyst 4 is lower than (TA+805° C.). When the temperature TC of the downstream, side end face of the reformer catalyst 4 is lower than (TA+805° C.), the routine proceeds to step 369 where a new learning value KG (=KG·C3·((TA+805° C.)−TC))) is calculated.

At this time, the learning value KG is decreased proportionally to the difference between the temperature TC of the downstream side end face of the reformer catalyst 4 and (TA+805° C.). That is, at this time, the amount of feed of fuel fed from the fuel injector 8 is decreased and the actual O₂/C molar ratio is made to approach the target O₂/C molar ratio. Next, the routine proceeds to step 370. On the other hand, when at step 368 it is judged that the temperature TC of the downstream side end face of the reformer catalyst 4 is not lower than (TA+805° C.), that is, when the temperature TC of the downstream side end face of the reformer catalyst 4 is between (TA+805° C.) and (TA+805° C.)+α, the routine proceeds to step 370. At this time, the learning value KG is not updated.

On the other hand, when it is judged at step 360 that the operating mode is not in the heat and hydrogen generating operating mode, that is, when it is judged that the operating mode is the heat generating operating mode, the routine proceeds to step 371 where the O₂/C molar ratio is, for example, set to 2.6. Next, at step 372, the target amount of feed of air QA is calculated from the target amount of feed of fuel QF and target O₂/C molar ratio calculated at step 351. Next, at step 373, fuel is injected from, the fuel injector 8 into the burner combustion chamber 3 by the target amount of feed of fuel QF calculated at step 351. Next, at step 373, the pump drive power required for making the target amount of feed of air QA calculated at step 372 be discharged from the air pump 15 is supplied to the air pump 15, while the air pump 15 discharges air by the target amount of feed of air QA. At this time, a complete oxidation reaction is performed by an O₂/C molar ratio=2.6 and only heat is generated. Next, the routine proceeds to step 370.

At step 370, it is judged if an instruction for stopping operation of the heat and hydrogen generation device 1 has been issued. The instruction for stopping operation of the heat and hydrogen generation device 1 is issued at the instruction generating part 39 shown in FIG. 1. When an instruction for stopping operation of the heat and hydrogen generation device 1 has not been issued, the routine returns to step 360. As opposed to this, when at step 370 it is judged that an instruction for stopping operation of the heat and hydrogen generation device 1 has been issued, the routine proceeds to step 375 where the feed of fuel from the injector 8 is stopped. Next, at step 376, air is fed from the air pump 15 so as to burn away the remaining fuel. Next, at step 377, it is judged if a fixed time has elapsed. When it is judged that the fixed time has not elapsed, the routine returns to step 376.

As opposed to this, when at step 377 it is judged that the fixed time has elapsed, the routine proceeds to step 378 where operation of the air pump 15 is stopped and the feed of air to the inside of the burner combustion chamber 3 is stopped. Next, at step 379, the low temperature air valve 17 is closed, while at step 380, the high temperature air valve 16 is opened. Next, while the operation of the heat and hydrogen generation device 1 is made to stop, the low temperature air valve 17 continues closed and the high temperature air valve 16 continues open.

Now then, as explained above, in the first embodiment according to the present Invention shown in FIG. 9 and FIG. 10, the actual O₂/C molar ratio at the time of the secondary warm-up operation is estimated from the rate of temperature rise of the reformer catalyst 4, amount of temperature rise of the reformer catalyst 4, or time required for temperature rise of the reformer catalyst 4 when performing the secondary warm-up operation. When the estimated actual O₂/C molar ratio deviates from the target O₂/C molar ratio, the ratio of feed between the amount of feed of air for burner combustion and the amount of feed of fuel for burner combustion is corrected in a direction making the estimated actual O₂/C molar ratio approach the target O₂/C molar ratio. On the other hand, in the second embodiment according to the present invention shown in FIG. 22 and FIG. 23, the actual O₂/C molar ratio at the time of the secondary warm-up operation is estimated from the rate of temperature rise of the reformer catalyst 4, amount of temperature rise of the reformer catalyst 4, or time required for temperature rise of the reformer catalyst 4 when performing the primary warm-up operation. When the estimated actual O₂/C molar ratio has deviated from, the target O₂/C molar ratio, the ratio of feed between the amount of feed of air for burner combustion and the amount of feed of fuel for burner combustion is corrected in a direction making the estimated actual O₂/C molar ratio approach the target O₂/C molar ratio.

Therefore, expressing this comprehensively, in the embodiment according to the present invention, in a heat and hydrogen generation device comprising the burner 7 arranged in the burner combustion chamber 3 for burner combustion, a fuel feed device able to control an amount of feed of fuel, for burner combustion fed into the burner combustion chamber 3, an air feed device able to control an amount of feed of air for burner combustion fed into the burner combustion, chamber 3, the ignition device 19 for making the fuel for burner combustion ignite, the reformer catalyst 4 to which burner combustion gas is sent, and the electronic control unit 30, an operation of the heat and hydrogen generation device 1 is switched from a warm-up operation to a normal operation when a temperature of the reformer catalyst 4 reaches a reaction equilibrium temperature TB. Target values of O₂/C molar ratio of air and fuel which are made to react in the burner combustion chamber 3 are preset as target O₂/C molar ratios for a time of the warm-up operation and for a time of the normal operation, respectively, and the electronic control, unit 30 is configured to estimate an actual O₂/C molar ratio at the time of the warm-up operation from a rate of temperature rise of the reformer catalyst, an amount of temperature rise of the reformer catalyst, or time required, for temperature rise of the reformer catalyst when performing the warm-up operation and correct a ratio of feed between the amount, of feed of air for burner combustion and the amount of feed of fuel for burner combustion in a direction making the estimated actual O₂/C molar ratio approach the target O₂/C molar ratio when the estimated actual O₂/C molar ratio deviates from the target O₂/C molar ratio.

In this case, in the embodiment according to the present invention, the target O₂/C molar ratio at the time of normal operation is set to an O₂/C molar ratio able to generate heat and hydrogen by a partial oxidation reforming reaction. Therefore, at the time of the normal operation, both heat and hydrogen are generated. In this case, the target O₂/C molar ratio at the time of the normal operation, is preferably set to 0.5.

Further, in the embodiment according to the present invention, the warm-up operation is comprised of the primary warm-up operation making the temperature of the reformer catalyst 4 rise by performing burner combustion under a lean air-fuel ratio and the secondary warm-up operation performed after a completion of the primary warm-up operation and making the temperature of the reformer catalyst 4 rise further by performing burner combustion under a rich air-fuel ratio and generate hydrogen at the reformer catalyst 4. In this case, in one embodiment according to the present invention, the actual O₂/C molar ratio at the time of warm-up operation is estimated from the rate of temperature rise of the reformer catalyst 4, amount of temperature rise of the reformer catalyst 4, or time required for temperature rise of the reformer catalyst 4 when performing the secondary warm-up operation. When the estimated actual O₂/C molar ratio when performing the secondary warm-up operation deviates from the target O₂/C molar ratio at the time of warm-up operation, the ratio of feed between the amount of feed of air for burner combustion and the amount of feed of fuel for burner combustion is corrected in a direction making the estimated actual O₂/C molar ratio approach the target O₂/C molar ratio at the time of warm-up operation.

That is, as shown in FIG. 3, in particular when a partial oxidation reforming reaction is being performed, the reaction equilibrium temperature TB of the reformer catalyst 4 changes greatly with respect to a change in the actual O₂/C molar ratio. On the other hand, at the time of the secondary warm-up operation, the temperature TC of the downstream side end face of the reformer catalyst 4 rises toward this reaction equilibrium temperature TB. Therefore, sit the time of the secondary warm-up operation, the rate of rise of the temperature of the reformer catalyst 4 changes greatly with respect to a change in the actual O₂/C molar ratio. Therefore, by estimating the actual O₂/C molar ratio at the time of warm-up operation from the rate of temperature rise of the reformer catalyst 4, amount of temperature rise of the reformer catalyst 4, or time required for temperature rise of the reformer catalyst 4 when performing the secondary warm-up operation, it is possible to precisely estimate the actual O₂/C molar ratio at the time of warm-up operation.

Further, in the embodiment according to the present invention, an actual O₂/C molar ratio at the time of the warm-up operation is estimated, from a rate of temperature rise of the reformer catalyst 4, an amount, of temperature rise of the reformer catalyst 4, or time required for temperature rise of the reformer catalyst 4 at the first half of said secondary warm-up operation time period, and a ratio of feed between the amount of feed of air for burner combustion and the amount of feed of fuel for burner combustion is corrected in a direction making the estimated actual O₂/C molar ratio approach the target O₂/C molar ratio when the estimated actual O₂/C molar ratio deviates from the target O₂/C molar ratio.

If in this way performing the work of estimating the actual O₂/C molar ratio at the time of warm-up operation in the first half of the secondary warm-up operation time period, it is possible to discover that the estimated actual O₂/C molar ratio deviates from the target O₂/C molar ratio at the time of the warm-up operation at an early timing at the time of the secondary warm-up operation. Therefore, it is possible to correct the ratio of feed between the amount of feed of air for burner combustion and the amount of feed of fuel for burner combustion early in a direction making the estimated actual O₂/C molar ratio approach the target O₂/C molar ratio at the time of warm-up operation.

Further, in the embodiment according to the present invention, the rate of temperature rise of the reformer catalyst 4 at the first half of the secondary warm-up operation time period when the actual O₂/C molar ratio matches the target O₂/C molar ratio is preset as the standard rate of temperature rise. When the rate of temperature rise of the reformer catalyst 4 at the first half of the secondary warm-up operation time period is lower than the preset standard rate of temperature rise, during the secondary warm-up operation, the ratio of feed between the amount of feed of air for burner combustion and the amount of feed of fuel for burner combustion is corrected in a direction where the estimated actual O₂/C molar ratio increases. That is, by just comparing the rate of temperature rise of the reformer catalyst 4 with the preset standard rate of temperature rise, it is possible to easily discover that the actual O₂/C molar ratio deviates from the target O₂/C molar ratio at the time of warm-up operation. In this case, when the rate of temperature rise of the reformer catalyst 4 is lower than the standard, rate of temperature rise, it is possible to judge that the actual O₂/C molar ratio is lower than the target O₂/C molar ratio at the time of warm-up operation. Therefore, in this case, during the secondary warm-up operation, the ratio of feed between the amount of feed of air for burner combustion and the amount of feed of fuel for burner combustion is corrected in a direction where the estimated actual O₂/C molar ratio increases.

Further, in the embodiment according to the present invention, the rate of temperature rise of the reformer catalyst at the first half of the secondary warm-up operation time period when the actual O₂/C molar ratio matches the target O₂/C molar ratio is preset as the standard rate of temperature rise. When the rate of temperature rise of the reformer catalyst 4 at the first half of the secondary warm-up operation time period is higher than the preset standard rate of temperature rise, at the time of start of the normal operation, the ratio of feed between the amount of feed of air for burner combustion and the amount of feed of fuel for burner combustion is corrected in a direction where the estimated actual O₂/C molar ratio falls. That is, as explained above, by just comparing the rate of temperature rise of the reformer catalyst 4 with the preset standard rate of temperature rise, it is possible to easily discover that the actual O₂/C molar ratio deviates from the target O₂/C molar ratio at the time of warm-up operation. In this case, when the rate of temperature rise of the reformer catalyst 4 is higher than the standard rate of temperature rise, it can be judged that the actual O₂/C molar ratio is higher than the target O₂/C molar ratio at the time of warm-up operation. Therefore, in this case, there is the danger of the reformer catalyst 4 degrading due to heat after the start of the normal operation, so at the time of start of the normal operation, the ratio of feed between the amount of feed of air for burner combustion and the amount of feed of fuel for burner combustion is corrected in a direction where the actual O₂/C molar ratio falls.

Further, in the embodiment according to the present invention, the actual O₂/C molar ratio at the time of warm-up operation is estimated from the rate of temperature rise of the reformer catalyst 4, amount of temperature rise of the reformer catalyst 4, or time required for temperature rise of the reformer catalyst 4 when performing the primary warm-up operation. When the actual O₂/C molar ratio estimated when performing the primary warm-up operation deviates from the target O₂/C molar ratio at the time of warm-up operation, the ratio of feed between the amount of feed of air for burner combustion and the amount of feed of fuel for burner combustion is corrected in a direction making the estimated actual O₂/C molar ratio approach the target O₂/C molar ratio at the time of warm-up operation when the secondary warm-up operation is started. That is, by correcting the ratio of feed between the amount of feed of air for burner combustion and the amount of feed of fuel for burner combustion when the secondary warm-up operation is started, it is possible to quickly make the actual O₂/C molar ratio approach the target O₂/C molar ratio at the time of warm-up operation.

Further, in the embodiment according to the present invention, at the normal operation, the actual O₂/C molar ratio is estimated from the temperature of the reformer catalyst 4. When the estimated actual O₂/C molar ratio deviates from the target O₂/C molar ratio at the time of the normal operation, the ratio of feed between the amount of feed, of air for burner combustion, and the amount of feed of fuel for burner combustion is corrected in a direction making the estimated actual. O₂/C molar ratio approach the target O₂/C molar ratio at the time of the normal operation. In this way, by correcting the ratio of feed between the amount of feed of air for burner combustion and the amount of feed of fuel for burner combustion in a direction making the actual O₂/C molar ratio approach the target O₂/C molar ratio at the time of normal operation, it is possible to make the actual O₂/C molar ratio much closer to the target O₂/C molar ratio at the time of the normal operation.

1. A heat and hydrogen generation device comprising:
a burner arranged in a burner combustion chamber for burner combustion,
a fuel feed device able to control an amount of feed of fuel for burner combustion fed into the burner combustion chamber,
an air feed device able to control, an amount of feed of air for burner combustion fed into the burner combustion chamber,
an ignition device for making the fuel for burner combustion ignite,
a reformer catalyst to which burner combustion gas is sent; and
an electronic control unit,
wherein an operation of the heat and hydrogen generation device is switched from a warm-up operation to a normal operation when a temperature of the reformer catalyst reaches a reaction equilibrium temperature, and target values of O₂/C molar ratio of air and fuel which are made to react in the burner combustion chamber are preset as target O₂/C molar ratios for a time of the warm-up operation and for a time of the normal operation, respectively,
said electronic control unit being configured to estimate an actual O₂/C molar ratio at the time of the warm-up operation from a rate of temperature rise of the reformer catalyst, an amount of temperature rise of the reformer catalyst, or time required for temperature rise of the reformer catalyst when performing the warm-up operation and correct a ratio of feed between the amount of feed of air for burner combustion and the amount of feed of fuel for burner combustion in a direction making the estimated actual O₂/C molar ratio approach the target O₂/C molar ratio when the estimated actual O₂/C molar ratio deviates from the target O₂/C molar ratio.

2. The heat and hydrogen generation device according to claim 1, wherein the target O₂/C molar ratio at the time of the normal operation is set to an O₂/C molar ratio able to generate heat and hydrogen by a partial oxidation reforming reaction.

3. The heat and hydrogen generation device according to claim 1, wherein the warm-up operation is comprised, of a primary warm-up operation making the temperature of the reformer catalyst rise by performing burner combustion under a lean air-fuel ratio and a secondary warm-up operation performed after a completion of the primary warm-up operation and making the temperature of the reformer catalyst rise further by performing burner combustion under a rich air-fuel ratio and generate hydrogen at the reformer catalyst, and said electronic control unit is configured to estimate an actual O₂/C molar ratio at the time of the warm-up operation from a rate of temperature rise of the reformer catalyst, an amount of temperature rise of the reformer catalyst, or time required for temperature rise of the reformer catalyst when performing said secondary warm-up operation and correct a ratio of feed between the amount of feed of air for burner combustion and the amount of feed of fuel for burner combustion in a direction making the estimated actual O₂/C molar ratio approach the target O₂/C molar ratio when the estimated actual O₂/C molar ratio deviates from the target O₂/C molar ratio.

4. The heat and hydrogen generation device according to claim 3, wherein said electronic control unit is configured to estimate an actual O₂/C molar ratio at the time of the warm-up operation from a rate of temperature rise of the reformer catalyst, an amount of temperature rise of the reformer catalyst, or time required for temperature rise of the reformer catalyst at the first half of said secondary warm-up operation time period and correct a ratio of feed between the amount of feed of air for burner combustion and the amount of feed of fuel for burner combustion in a direction making the estimated actual O₂/C molar ratio approach the target O₂/C molar ratio when the estimated actual O₂/C molar ratio deviates from the target O₂/C molar ratio.

5. The heat and hydrogen generation device according to claim 4, wherein the rate of temperature rise of the reformer catalyst at the first half of the secondary warm-up operation time period when the actual O₂/C molar ratio matches the target O₂/C molar ratio is preset as a standard rate of temperature rise, and said electronic control unit is configured to correct the ratio of feed between the amount of feed of air for burner combustion and the amount of feed of fuel for burner combustion in a direction where the estimated actual O₂/C molar ratio increases during said secondary warm-up operation when the rate of temperature rise of the reformer catalyst at the first half of said secondary warm-up operation time period is lower than said preset standard rate of temperature rise.

6. The neat and hydrogen generation device according to claim 4, wherein the rate of temperature rise of the reformer catalyst at the first half of the secondary warm-up operation time period when the actual O₂/C molar ratio matches the target O₂/C molar ratio is preset as a standard rate of temperature rise, and said electronic control unit is configured to correct the ratio of feed between the amount of feed of air for burner combustion and the amount of feed of fuel for burner combustion in a direction where the estimated actual O₂/C molar ratio decreases at the time of start of said normal operation when the rate of temperature rise of the reformer catalyst at the first half of said secondary warm-up operation time period is higher than said preset standard rate of temperature rise.

7. The heat and hydrogen generation device according to claim 1, wherein the warm-up operation is comprised of a primary warm-up operation making the temperature of the reformer catalyst rise by performing burner combustion under a lean, air-fuel ratio and a secondary warm-up operation performed, after a completion of the primary warm-up operation and making the temperature of the reformer catalyst, rise further by performing burner combustion under a rich air-fuel ratio and generate hydrogen at the reformer catalyst, and said electronic control unit is configured to estimate an actual O₂/C molar ratio at the time of the warm-up operation from a rate of temperature rise of the reformer catalyst, am amount of temperature rise of the reformer catalyst, or time required for temperature rise of the reformer catalyst when performing said primary warm-up operation and correct a ratio of feed between the amount of feed of air for burner combustion and the amount of feed of fuel, for burner combustion in a direction making the estimated, actual O₂/C molar ratio approach the target O₂/C molar ratio when the estimated actual O₂/C molar ratio deviates from the target O₂/C molar ratio.

8. The heat and hydrogen generation device according to claim 1, wherein said electronic control unit is configured to estimate the actual O₂/C molar ratio from the temperature of the reformer catalyst at the normal operation and correct the ratio of feed between the amount of feed of air for burner combustion and the amount of feed of fuel for burner combustion, in a direction making the estimated actual O₂/C molar ratio approach the target O₂/C molar ratio at the time of the normal operation when the estimated, actual O₂/C molar ratio deviates from said target O₂/C molar ratio at the time of the normal operation.

9. The heat and hydrogen generation device according to claim 1, wherein, an allowable catalyst temperature enabling heat degradation of the reformer catalyst to be avoided is preset, and said electronic control unit is configured to control said air feed device to make the temperature of the air fed from said burner into said burner combustion chamber fall so as to maintain the temperature of the reformer catalyst at said allowable catalyst temperature or less if the temperature of the reformer catalyst exceeds said allowable catalyst temperature or it is predicted that the temperature of the reformer catalyst would exceed said allowable catalyst temperature when the burner combustion is performed.

10. The heat and hydrogen generation device according to claim 9, wherein said heat and hydrogen generation device further comprises a heat exchange part for heating the air fed from the burner into the burner combustion chamber by a combustion gas flowing out from the reformer catalyst and a switching device for switching an air flow route for feeding air from said burner into said burner combustion chamber between a high temperature air flow route for feeding air heated at said heat exchange part and a low temperature air flow route for feeding air of a temperature lower than the air heated at said heat exchange part, and said electronic control unit is configured to switch the air flow route for feeding air from said burner into said burner combustion chamber from, said high temperature air flow route to said low temperature air flow route when making the temperature of the air fed into said burner combustion chamber fall.
